(19) United States
(12) Patent Application Publication
(10) Pub. No.: US 2015/0161307 A1
(43) Pub. Date: Jun. 11, 2015

(54) Method of Designing Semiconductor Device, Designing Assistance Program, Designing Apparatus, and Semiconductor Device

(71) Applicant: Renesas Electronics Corporation, Kawasaki-shi (JP)

(72) Inventor: Hiroshi UEKI, Kawasaki-shi (JP)

(21) Appl. No.: 14/560,826

(22) Filed: Dec. 4, 2014

(30) Foreign Application Priority Data
Dec. 5, 2013 (JP) 2013-252039

(51) Int. Cl. G06F 17/50

(52) U.S. Cl. CPC G06F 17/5027; G06F 17/5068; G06F 2217/62; G06F 2217/68; G06F 2217/78

(57) ABSTRACT

The present invention provides a method of designing a semiconductor device capable of executing a DVFS control which minimizes consumption energy. A consumption power profile P(t) when a known operating voltage and a clock of a known frequency are given to a logic circuit as a DVFS target and a process as a DVFS target is executed is obtained. The obtained power profile is converted to a function related to a clock cycle q(t), and a load capacity of the target logic circuit is obtained as a function of the clock cycle q(t). An operating voltage and an operating frequency are calculated as functions (V(q), f(q)) for a clock cycle so as to satisfy a condition using, as a constant, a product (C(q)·(dq/dt)\textcircled{}3) of the load capacity function and cube of time differentiation of the clock cycle. The calculated functions of the operating voltage and the operating frequency are solutions of the Euler equation according to the calculus of variations, and consumption energy is minimized.

### CROSS-REFERENCE TO RELATED APPLICATIONS

The disclosure of Japanese Patent Application No. 2013-252039 filed on Dec. 5, 2013 including the specification, drawings and abstract is incorporated herein by reference in its entirety.

### BACKGROUND

The present invention relates to a method of designing a semiconductor device, a designing assistance program, a designing apparatus, and a semiconductor device and, more particularly, can be suitably used for a semiconductor device whose consumption power can be reduced by dynamically controlling an operating frequency and an operating voltage.

There is a known technique which reduces consumption power of a semiconductor device, particularly, a CMOS (Complementary Metal Oxide Semiconductor) digital circuit by dynamically controlling an operating frequency and an operating voltage (DVFS (Dynamic Voltage and Frequency Scaling) control).

Non-patent literature 1 discloses an MPEG (Moving Picture Experts Group) decoder dynamically controlling an operating frequency and an operating voltage on a frame unit basis of an image. Processes are divided into a process depending on frames and a process independent of the frame process, time required to a decoding process is predicted, and optimum operating frequency and operating voltage are determined.

Patent literature 1 discloses a dynamic voltage control method for reducing consumption power by controlling a power supply voltage and a clock frequency to be supplied to a processor. A dynamic power controller which specifies a demand for the clock frequency of the processor and supplies a proper power supply voltage level on the basis of the demand is described.

### RELATED ART LITERATURE

### Patent Literature

Patent Literature 1: Japanese Unexamined Patent Application Publication No. 2009-64456

### Non-Patent Literature

Non-Patent Literature 1: Kihwan Choi et al., “Frame-based dynamic voltage and frequency scaling for a MPEG decoder”, the Processings of the 2002 IEEE/ACM international conference on Computer-aided design, U.S.A., IEEE, issued in 2002, Pages 732-737

### SUMMARY

The inventors of the present invention examined the non-patent literature 1 and the patent literature 1 and, as a result, found out that there is another problem as described below.

In the conventional DVFS control, in one process to be completed within given time T, by controlling to a minimum operating frequency f and a minimum operating voltage V for completing the process, consumption power can be reduced. First, the minimum operating frequency f necessary to complete the process within the time T is obtained. The minimum operating frequency f is calculated by “the number of clocks necessary for process”÷T. When an operating voltage which is lowest to assure circuit operation at the frequency f is set as V, the circuit is operated at the lowest operating frequency f and the lowest operating voltage V. That is, in the DVFS control, by reducing the operating frequency f and the operating voltage V in the following calculation equation of the power in the semiconductor circuit, the value of the power P can be reduced.

P=fCV²+L Equation 1

P denotes consumption power, f denotes operating frequency, C denotes a total load capacity of an amount contributed to circuit operation, V denotes operating voltage, and L denotes leak power.

However, as a result of examination of the inventors of the present invention, it was found out that the consumption power cannot be reduced to the real minimum consumption power by the conventional minimum operating frequency and minimum operating voltage. In the conventional DVFS control, during the time T in which the process is executed, the operating frequency is kept constant at the lowest operating frequency f and the operating voltage is maintained constant at the lowest voltage operating voltage V, and the consumption power is reduced. By further subdividing the process and performing the DVFS control in a unit of finer time, it is expected that the consumption power can be more reduced. In this method, however, the lowest operating frequency and the lowest operating voltage have to be calculated for each subdivided time, and the subdivision is limited to suppress the calculation amount to an amount which is allowed in reality. Consequently, by the conventional DVFS control, consumption power cannot be reduced to the real minimum consumption power.

Means to solve such a problem will be described below. The other problems and novel features will become apparent from the description of the specification and appended drawings.

An embodiment for solving the problem is as follows.

A known operating voltage and the clock of a known frequency are given to a logic circuit as a DVFS target, and a power profile when a process as a DVFS target is executed is provided. The power profile is expressed by a function P(q) of consumption power for the clock cycle q. The load capacity of the target logic circuit is obtained as the function of the clock cycle q. On the basis of the function of the load capacity, the operating voltage V(q) and the operating frequency f(q) are calculated to satisfy an Euler equation on the consumption power P and the clock cycle q. On the basis of functions of the operating voltage and the operating frequency calculated, the DVFS control is performed on the target logic circuit.

An effect obtained by the embodiment will be briefly described as follows.

The functions (V(q), f(q)) of the operating voltage and the operating frequency calculated are determined so as to satisfy the Euler equation. Therefore, the semiconductor device capable of executing the DVFS control which reduces consumption energy more can be designed.

### BRIEF DESCRIPTION OF THE DRAWINGS

FIG. 1 is a flowchart illustrating a method of designing a semiconductor device according to a first embodiment.

FIG. 2 is a graph (consumption power profile) expressing time fluctuations of consumption power P when a target circuit is operated at predetermined frequency f under DVFS control.

FIG. 3 is a graph obtained by changing the variable of the horizontal axis of the graph expressing time fluctuations of the consumption power P illustrated in FIG. 2 to q(t).

FIG. 4 is a graph expressing time fluctuations of a clock count q(t).

FIG. 5 is a power profile assumed to quantify the effect of reduction in consumption energy by an algorithm of the embodiment.

FIG. 6 is a table expressing a calculation example in which the effect of reduction in consumption energy by the algorithm of the embodiment is quantified.

FIG. 7 is an explanatory diagram expressing an example of a method of designing a semiconductor device to which the algorithm of the embodiment is applied.

FIG. 8 is an explanatory diagram expressing an example of applying a method of designing a semiconductor device according to a second embodiment.

FIG. 9 is an explanatory diagram expressing an example of a program before control data 4 is included.

FIG. 10 is a schematic waveform chart expressing an example of a power profile 2 obtained.

FIG. 11 is a table expressing an example of the calculated control data 4.

FIG. 12 is an explanatory diagram expressing an example of a program after the control data 4 is included.

FIG. 13 is an explanatory diagram expressing an example of applying a method of designing a semiconductor device according to a third embodiment.

FIG. 14 is a table expressing an example of the calculated control data 4.

FIG. 15 is an explanatory diagram expressing an example of applying a method of designing a semiconductor device according to a fourth embodiment.

FIG. 16 is an explanatory diagram expressing an example of a program executed by a DVFS control target circuit (such as a CPU) 8.

FIG. 17 is a table expressing an example of numerical values of the calculated control data 4 and a state in which the values are stored in a memory 9.

FIG. 18 is a block diagram expressing a configuration example of a microcomputer including the DVFS control target circuit 8 having a plurality of IPs.

FIG. 19 is a schematic waveform chart expressing an example of a power profile 2 before a software change.

FIG. 20 is a schematic waveform chart expressing an example of the power profile 2 after a software change.

FIG. 21 is a table expressing an example of numerical values of an effect of reduction of consumption power in the case of adjusting the degree of parallelism.

FIG. 22 is a block diagram expressing an example of the configuration of a microcomputer according to a sixth embodiment.

FIG. 23 is a schematic waveform chart expressing an example of the obtained power profile 2.

FIG. 24 is a table expressing an example of the calculated control data 4.

### DETAILED DESCRIPTION

### 1. Outline of Embodiments

First, outline of a representative embodiment disclosed in the present application will be described. A reference numeral in the drawings referred to in parentheses in the description of the outline of the representative embodiment merely indicates an object included in the concept of a component to which the reference numeral is designated.

[1] Calculation of Load Capacity as Function of Clock Cycle from Power Profile

A representative embodiment disclosed in the present application relates to a method of designing a semiconductor device, by executing a designing assistance program by a computer, for a logic circuit (8) to which an operating voltage and an operating frequency are given and which executes a predetermined process synchronously with a clock signal, and calculating an operating voltage and an operating frequency of the logic circuit in a period in which the process is executed. The method includes the following steps.

A relation of consumption power to time when a first operating voltage (V0) and a first operating frequency (f0) are given to the logic circuit and the logic circuit is made execute the process is obtained as a power profile (P(t), 2) (S1).

On the basis of the power profile, a function of load capacity of the logic circuit for the clock cycle (q(t)) accompanying execution of the process is obtained as a load capacity function (C(q)) (S4).

On the basis of the load capacity function (C(q)), the operating voltage and the operating frequency of the logic circuit in the period in which the process is executed are calculated as ideal functions (V(q), f(q)) for the clock cycle so as to satisfy an Euler equation on power and a clock cycle (S5).

By the above, a semiconductor device capable of executing DVFS control which reduces consumption energy can be designed.

As a condition of satisfying an Euler equation, a case of using a product (C(q)·(dq/dt)\textcircled{}3) of the load capacity function and cube of time differentiation of the clock cycle as a constant is exemplified. The operating voltage and the operating frequency are calculated so as to satisfy (C(q)·(dq/dt)\textcircled{}3)=constant by using the calculated C(q).

### [2] Method of Calculating Load Capacity Function

In the item [1], the first operating voltage and the first operating frequency are constant in the period of executing the process, the power profile is converted to a function related to the clock cycle (P(q), S3), and the load capacity function is calculated from the converted power profile, the first operating voltage, and the first operating frequency (C(q)=(P(q)−L(q))/(f0·V0²) (S4).

Consequently, the relation (load capacity function C(q)) between the clock cycle and the load capacity can be easily calculated.

### [3] Include Instruction of Setting Operating Voltage and Operating Frequency in Program

In the item [1] or [2], the logic circuit can execute a program (15), and includes a processor (8, 21) capable of setting an operating voltage and an operating frequency by an instruction included in the program.

An instruction of setting the operating voltage and the operating frequency on the basis of an operating voltage (V(q)) and an operating frequency (f(q)) each calculated as a function for a clock cycle is added to a program executing the process.

Consequently, a processor executing the DVFS control by the program executed by itself can execute the DVFS control which minimizes consumption energy. An operating voltage and an operating frequency to be set by the instruction can be obtained by approximating an operating voltage and an operating frequency calculated as functions for a clock cycle by a stair-shaped function.

### [4] Control Data Setting Operating Voltage and Operating Frequency

In the item [1] or [2], a control circuit (5) capable of setting an operating voltage and an operating frequency supplied to the logic circuit is coupled to the logic circuit.

The control circuit has a clock counter (10) and control data (4) specified by associating an operating voltage and an operating frequency to a clock cycle value can be hold (9, 90 to 9n). The control circuit compares a count value by the clock counter and a clock cycle value specified in the control data and, when they match, can set a corresponding operating voltage and a corresponding operating frequency as an operating voltage and an operating frequency to be supplied to the logic circuit (17).

In the method of designing the semiconductor device, the control data is generated on the basis of an operating voltage and an operating frequency each calculated as a function for the clock cycle.

Consequently, in the logic circuit which operates according to a clock cycle, the DVFS control which minimizes consumption energy can be executed. An operating voltage and an operating frequency to be set in the clock cycle can be obtained by approximating an operating voltage and an operating frequency calculated as functions for a clock cycle by a stair-shaped function.

[5] Control Data having Setting Values of All of Clock Cycles

In the item [4], the control data includes operating voltages and operating frequencies to be set for all of clock cycles in the process.

Consequently, a semiconductor device capable of executing an ideal DVFS control in which consumption energy is theoretically minimized can be designed.

### [6] CAD (Computer Aided Design) Program

A representative embodiment disclosed in the present application relates to a designing assistance program, by being executed by a computer, making the computer execute the method of designing a semiconductor device according to any one of the items [1] to [5].

Consequently, a CAD program for designing a semiconductor device capable of executing a DVFS control in which consumption energy is minimized can be provided.

### [7] Acquisition of Power Profile by Simulation

In the item [6], the power profile is calculated by a simulation on the basis of netlist information in the logic circuit.

Consequently, a power profile in a cycle base can be obtained easily without measuring consumption power of a logic circuit by a real device.

### [8] CAD System

A representative embodiment disclosed in the present application relates to a designing apparatus having a computer executing a designing assistance program according to the item [6] or [7].

Consequently, a CAD system for designing a semiconductor device capable of executing a DVFS control in which consumption energy is minimized can be provided.

### [9] Microcomputer

A representative embodiment disclosed in the present application relates to a semiconductor device (20) including a processor (21), a memory (22, 23) capable of storing a program to be supplied to the processor, a clock supply circuit (6) capable of supplying a clock to the processor, a power supply circuit (7) capable of supplying power to the processor, and a control circuit (5) and configured as follows.

The control circuit has a frequency control register (13) capable of setting frequency of the clock supplied from the clock supply circuit to the processor, and a voltage control register (14) capable of setting voltage of the power supplied from the power supply circuit to the processor.

An instruction set of the processor includes an instruction capable of setting a value in each of the frequency control register and the voltage control register.

The program includes a routine of making the processor execute a predetermined process, and the routine includes an instruction of setting an operating voltage and an operating frequency.

The operating voltage and the operating frequency set in the routine are calculated as follows on the basis of an operating voltage function (V(q)) and an operating frequency function (f(q)) each calculated as a function for a clock cycle when the routine is executed.

A relation of consumption power to a clock cycle accompanying execution of the routine when a first operating frequency and a first operating frequency are given and the processor is made execute the routine is obtained as a power profile (P(q)). A relation of load capacity of the processor for the clock cycle (q(t)) is obtained as a load capacity function (C(q)) on the basis of the power profile (S4). The operating voltage function and the operating frequency function (V(q), f(q)) are calculated so as to satisfy an Euler equation with respect to the power and the clock cycle on the basis of the load capacity function (S5).

Consequently, an LSI (Large Scale Integrated circuit) such as a microcomputer including a processor capable of executing a DVFS control in which consumption energy is minimized can be provided.

### [10] Microcomputer Having Plural CPUs

In the item [9], the processor includes a plurality of CPUs (21_1 to 21_4).

Consequently, in an LSI such as a microcomputer having a plurality of CPUs and capable of executing a parallel process, while properly adjusting the degree of parallelism, a DVFS control in which consumption energy is minimized can be executed.

### [11] Single Chip

In the item [9] or [10], the semiconductor device is mounted on a single semiconductor substrate.

Consequently, in an LSI such as a single-chip microcomputer, a DVFS control in which consumption energy is minimized can be executed.

### [12] Dedicated Hardware

A representative embodiment disclosed in the present application relates to a semiconductor device including a logic circuit (8) which operates synchronously with a clock, a clock supply circuit (6) capable of supplying the clock to the logic circuit, a power supply circuit (7) capable of supplying power to the logic circuit, and a control circuit (5) and configured as follows.

The control circuit has a frequency control register (13) capable of setting frequency of the clock supplied from the clock supply circuit to the logic circuit, a voltage control register (14) capable of setting voltage of the power supplied from the power supply circuit to the logic circuit, and a memory (9, 90 to 9n) capable of holding control data (4) in which an operating voltage and an operating frequency are specified so as to be associated with a clock cycle value. The control circuit is configured so as to be able to set a corresponding operating voltage and a corresponding operating frequency in the frequency control register and the voltage control register, respectively when a clock cycle in operation of the logic circuit and a clock cycle value held in the memory match.

The control data is calculated as follows on the basis of an operating voltage function (V(q)) and an operating frequency function (f(q)) each calculated as a function for a clock cycle when the logic circuit executes the process.

A relation of consumption power to a clock cycle accompanying execution of the routine when a first operating frequency and a first operating frequency are given and the logic circuit is made execute the routine is obtained as a power profile (P(q)) (S1). A relation of load capacity of the logic circuit for the clock cycle (q(t)) is obtained as a load capacity function (C(q)) on the basis of the power profile (S4). The operating voltage function and the operating frequency function (V(q), f(q)) are calculated so as to satisfy an Euler equation with respect to the power and the clock cycle on the basis of the load capacity function (S5).

Consequently, an LSI including dedicated hardware capable of executing a DVFS control in which consumption energy is minimized can be provided. The logic circuit (8) may be general or programmable general hardware such as a processor or dedicated hardware specialized for any signal process or the like. In the case where the logic circuit (8) is a processor, different from the item [9] or [10], it is unnecessary to modify a program.

### [13] Data Register Holding Setting Value of Change Point

In the item [12], the memory includes a plurality of data registers (90 to 9n), and the control circuit further includes a clock counter (10) for counting the clock and a match detection circuit (17) comparing a count value by the clock counter and a clock cycle value specified in the control data.

In the plurality of data registers, setting data specifying an operating voltage and an operating frequency corresponding to a clock cycle value specified in the control data is held.

When the match detection circuit detects that the count value by the clock counter and the clock cycle value held in the data registers match, setting data specifying a corresponding operating voltage and a corresponding operating frequency can be set into the frequency control register and the voltage control register, respectively.

Consequently, in the case where the control data 4 is approximated by a stair-like control, by providing a limited number of data registers holding only the setting data specifying an operating voltage and an operating frequency at a change point in association with a clock cycle value, an LSI including dedicated hardware capable of executing a DVFC control in which consumption energy is minimized can be provided. The logic circuit (8) may be general or programmable general hardware such as a processor or dedicated hardware specialized for any signal process or the like.

### [14] Memory Holding Control Data Every Cycle

In the item [12], the control circuit further includes a clock counter (10) for counting the clock. The memory stores setting data specifying a corresponding operating voltage and a corresponding operating frequency, in an address corresponding to a clock cycle value of the control data. A clock cycle value which is output from the clock counter is supplied as an address to the memory, and setting data specifying a corresponding operating voltage and a corresponding operating frequency is read. The control circuit can set the setting data specifying the operating voltage and the operating frequency read from the memory into the frequency control register and the voltage control register, respectively.

Consequently, in the memory (9), all of the frequency and voltage control data (4) based on an Euler equation solution according to a calculus of variations can be stored cycle by cycle in the memory without approximating it, so that ideal DVFC control in which the consumption energy is theoretically minimized can be performed. Also in the case where a DVFS target circuit is dedicated hardware having no processor or a special processor which does not allow modification of a program, similarly, the DVFS control based on frequency and voltage control data based on an Euler equation solution according to a calculus of variations can be performed.

### [15] Nonvolatile Memory Holding Control Data

In the item [14], the memory is a nonvolatile memory.

Consequently, the calculated control data (4) can be written in the memory (9) as a nonvolatile memory before shipment and, for example, a device in which control data optimized for each device us written can be shipped.

### [16] Single Chip

In the item [12] or [15], the semiconductor device is mounted on a single semiconductor substrate.

Consequently, in a single-chip LSI, the DVFS control in which consumption energy is minimized can be executed.

### 2. Details of Embodiments

The embodiments will be described more specifically.

### First Embodiment

DVFS Control Based on Euler Equation Solution According to Calculus of Variations

### Algorithm

The principle that an ideal DVS control in which consumption energy is theoretically minimized can be executed by the above-described representative embodiment will be described specifically.

Generally, when consumption power is expressed as P, consumption energy (power amount) is expressed as E, and time is expressed as t, the following integral equation is satisfied with respect to E.

E=∫Pdt Equation 2

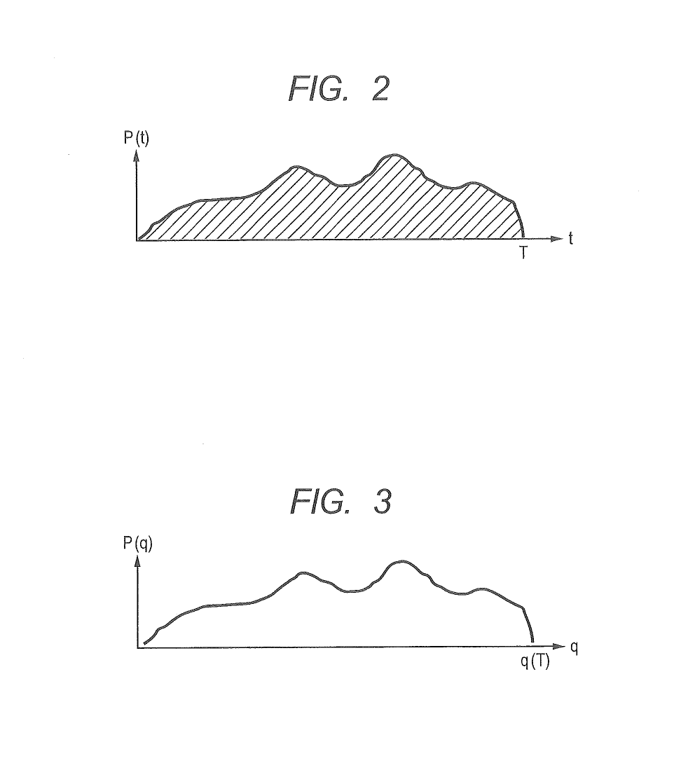

FIG. 2 is a graph illustrating time fluctuations of the consumption power P when a DVFS control target circuit (logic circuit) 8 is operated at the constant frequency f in DVFS control. In the actual logic circuit 8, even in the case of performing an operation while maintaining a period of executing a target process and an operating frequency to be constant, the consumption power P fluctuates with time as illustrated in FIG. 2.

The reason why P fluctuates with time even when the operating frequency f is set constant in the DVFS control is that, as understood from Equation 1, the total load capacity C is the function of the time t. Since only the capacitance charged/discharged at time t contributes to the consumption power P, the sum of the value of all of capacitances of the operation is C. As understood from Equation 2, the value of the area of the consumption power P illustrated by hatching in FIG. 2 is the value of the consumption energy E.

A clock supplied to the target logic circuit 8 is introduced at time t by setting the variable indicative of the number of the cock counted from the start time 0 of a target process to q(t). FIG. 3 is a graph obtained by changing the variable of the horizontal axis of the graph expressing time fluctuations of the consumption power P illustrated in FIG. 2 to q(t). Although the consumption power P is observed as the function of the time t as illustrated in FIG. 2, it can be considered as the function of q(t) in essence. Since the total load capacity C and the leak power L in Equation 1 can be also generally considered as the functions of q(t), they can be expressed as C(q) and L(q), respectively for a reason that the target logic circuit 8 is a circuit which operates synchronously with a clock. At this time, the operating frequency f is equal to a first-order differentiation of q, it can be expressed by the following equation.

$$f = \frac{d q}{d t} \qquad Equation 3$$

Since the operating voltage V is controlled as the function V(f) of the operating frequency f in the DVFS control, it can be expressed as V(dq/dt). In the DVFS control, for example, a control can be performed like V(dq/dt)=a·dq/dt (a is a constant).

When the above-described variable definition is substituted to Equation 1, the following equation 4 is obtained. Further, when the variable definition is substituted to Equation 2, Equation 5 is derived.

$$\begin{matrix}P = \frac{d q}{d t} \cdot C ( q ) \cdot {V ( \frac{d q}{d t} )}^{2} + L ( q ) . & Equation 4 \\ \begin{matrix}E = \int P d t \\ = \int ( \frac{d q}{d t} \cdot C ( q ) \cdot {V ( \frac{d q}{d t} )}^{2} + L ( q ) ) d t\end{matrix} & Equation 5\end{matrix}$$

It is understood from Equation 5 that the consumption energy E is a generalized variable of the variable q(t) and, according to the function form of q(t), an integral value E increases/decreases.

To obtain q(t) which minimizes the value of the consumption energy E calculated by Equation 5, the mathematic of a calculus of variations is applied to Equation 5. At this time, it is indicated that the following Euler equation is satisfied from the condition of minimizing the value of Equation 5.

$$\frac{d}{d t} ( \frac{\partial P}{\partial ( d q / d t )} ) - \frac{\partial P}{\partial q} = 0 \qquad Equation 6$$

According to the calculus of variations, the solution q(t) of Equation 6 gives the minimum value of the value of Equation 5 under a restraint condition in which the start point (start time) and the end point (end time) of the integral of Equation 5 are fixed. That is, by substituting the consumption power P expressed by Equation 4 into Equation 6 to solve the differential equation, a method of frequency/voltage control to minimize the consumption energy E by q(t) calculated as the solution, that is, the functions f(t) and V(t) giving the optimum operating frequency and operating voltage at the time t are obtained.

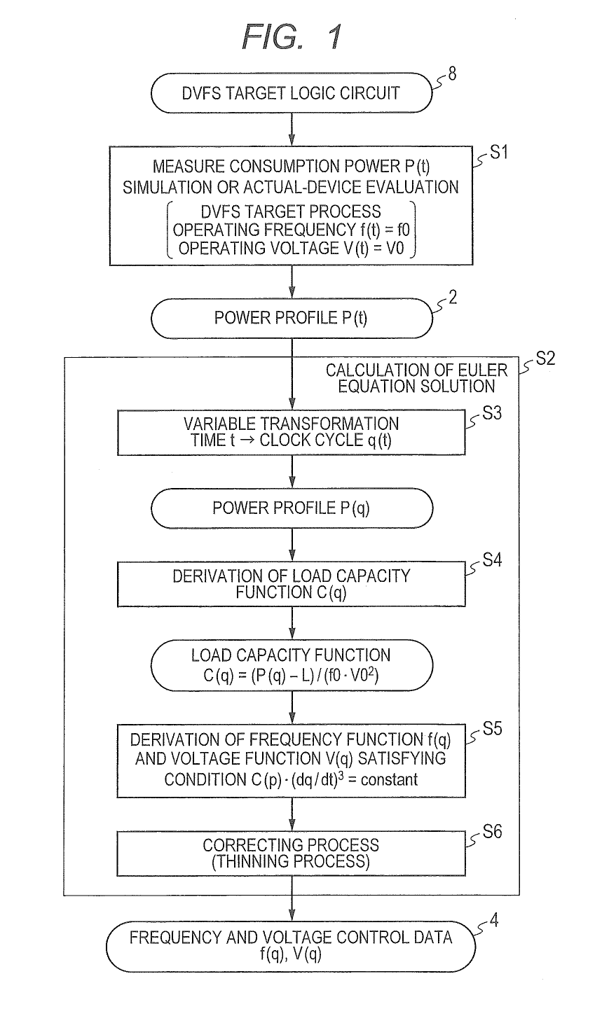

FIG. 1 is a flowchart expressing a method of designing a semiconductor device according to a first embodiment.

First, the logic circuit 8 as a target of the DVFS control is made execute a target process of the DVFS control to measure a time change in the consumption power P (S1). Although the operating frequency and the operating voltage at this time are not particularly limited, it is sufficient to give appropriate predetermined values such as f(t)=f0 and v(t)=V0. The consumption power measurement may be performed by simulation or actual device evaluation. As a result, a power profile P(t) (2) is obtained. In reality, the power profile is obtained as discrete values of the powers P=P1, P2, P3, . . . and PN at times t=t1, t2, t3, . . . , and tN, respectively. Time tm is expressed as tm=m/f0, and m indicates an integer ranging from 1 to N. That is, N sets of power profiles of (t, P)=(t1, P1), (t2, P2), (t3, P3), . . . , and (tN, PN) are obtained.

Next, on the basis of the obtained power profile P(t) (2), the operating frequency and operating voltage of the logic circuit 8 are calculated (S2). The step S2 including steps S3 to S6 which will be described later is realized by executing a program by a computer.

The calculation of the operating frequency and the operating voltage is characterized by use of the Euler equation for the power and clock cycle. Therefore, the step S2 is also called a step of calculating the Euler equation solution.

Concretely, first, variable transformation is performed (S3). Specifically, the above-described clock cycle function q(t) is introduced, and the time t=t1, t2, . . . , tN is transformed to q=q1, q2, . . . , qN. In the case where the time tm=m/f0, the clock cycle is simply expressed by the integer of q=1, 2, 3, . . . N. That is, the clock cycle q(t) indicates the clock count number from the start point t=0 to time t. The power profile P(t) is rewritten to the function P(q) regarding the clock cycle q(t), and power profiles in which the powers P=P1, P2, P3, . . . , and PN are associated with the clock cycles q=1, 2, 3, . . . , and N, respectively, are generated. That is, the power profiles (1, P1), (2, P2), (t3, P3), . . . and (N, PN) obtained by variable transformation from (t, P) to (q, P) are provided.

With respect to the load capacity C and the leak power L as well, similarly, the load capacity function C(q) and the leak power function L(q) related to the clock cycle q(t) are obtained from the power profile information P(t)=P(q) and the function form of Equation 4 is determined. In Equation 4, the following values are known values.

The value P is determined for each value q from power profile data.

dq/dt is given by a frequency value (for example, f(t)=f(0)) at the time of acquisition of the power profile.

V(dq/dt) is given by a voltage value (for example, V(t)=V0) at the time of acquisition of the power profile.

L(q) denotes leak power, so that it can be generally specified as a certain predetermined value L regardless of q.

Since values of constants are given except for C(q) in Equation 4, by solving Equation 4 with respect to C(q), C(q)=(P(q)−L)/(f0·V0²) is determined (S4). Therefore, the load capacity functions related to the clock cycle are obtained in a form that C=C1, C2, C3, . . . , CN are associated with q=1, 2, 3, . . . N, respectively. In this case, Cm=(Pm−L)/(f0·V0²) is satisfied.

On the other hand, q(t) obtained by substituting Equation 4 to Equation 6 as an Euler equation is an Euler equation solution. The operating frequency and operating voltage satisfying the Euler equation solution q(t) are obtained.

In the case of performing approximation as C=C(q), V=a·dq/dt, L=0 in Equation 4 as a realistic approximation as an operation of the semiconductor device, the consumption power P(q) is expressed by the following equation. “a” denotes a positive integer.

$$\begin{matrix}P = \frac{d q}{d t} \cdot C ( q ) \cdot {V ( \frac{d q}{d t} )}^{2} \\ = {a}^{2} \cdot C ( q ) \cdot {( \frac{d q}{d t} )}^{3} .\end{matrix} \qquad Equation 7$$

As a condition satisfying the Euler equation of Equation 6 under the relation of Equation 7, the following equation is given from a first integral of the Euler equation of Equation 6.

$$C ( q ) \cdot {( \frac{d q}{d t} )}^{3} = k ( constant ) \qquad Equation 8$$

It is therefore understood that, in the case of C=C(q), V=a·dq/dt, and L=0, by performing the DVFS control so that the consumption power P(t) becomes constant regardless of the time t within time in which the process has to be performed, the minimum energy is given. By solving Equation 8, the following equation 9 is obtained and becomes a condition to satisfy an Euler equation. In other words, Equation 9 itself is a solution of an Euler equation.

$$\frac{d q}{d t} = {( \frac{k}{C ( q )} )}^{1 / 3} \qquad Equation 9$$

From the above, the operating frequency f(q) and the operating voltage V(q) giving the minimum energy can be obtained (S5).

Concretely, from the relation of Equation 3, f=(k/C(q))^{1/3}. As C(q), the load capacity functions (C1, C2, C3, . . . CN) obtained in step S4 are used. Therefore, the operating frequency f can be easily obtained in the form of f=f1, f2, f3, . . . fN for q=1, 2, 3, . . . N, respectively. In this case, fm=(k/Cm)^{1/3}={(k·f0·V0²)/(Pm−L)}^{1/3}.

From the relation of V=a·dq/dt=a·f, the operating voltage V is obtained in the form of V=V1, V2, V3, . . . VN for q=1, 2, 3, . . . N, respectively. In this case, Vm=a·fm=a·(k/Cm)^{1/3}=a·{(k·f0·V0²)/(Pm−L)}^{1/3}. k is obtained as follows.

From Equation 9, ∫k^{1/3}dt=IC(q)^{1/3}dq is obtained. The left side means that the function k^{1/3} is integrated within the range of t=0 to tN. Since k is a constant, simply k^{1/3}·tN is obtained. The right side is calculated as ΣCm^{1/3}=(C1)^{1/3}+(C2)^{1/3}+(C3)^{1/3}+ . . . +(CN)^{1/3} by using the load capacity functions (C1, C2, C3, . . . CN) obtained in step S4. Therefore, k=[{(C1)^{1/3}+(C2)^{1/3}+(C3)^{1/3}+ . . . +(CN)^{1/3}}/tN]³ can be obtained. In such a manner, (q, f, V)=(1, f1, V1), (2, f2, V2), (3, f3, V3), . . . (N, fN, VN) becomes control data (f(q), V(q)) (4) of the operating frequency and the operating voltage for the clock cycle number.

Since the control data is calculated so as to satisfy the Euler equation on the basis of the load capacity function derived in S4, the DVFS control which minimizes consumption power energy as much as possible is given. Consequently, a semiconductor device capable of executing the DVFS control which can minimize consumption energy can be designed.

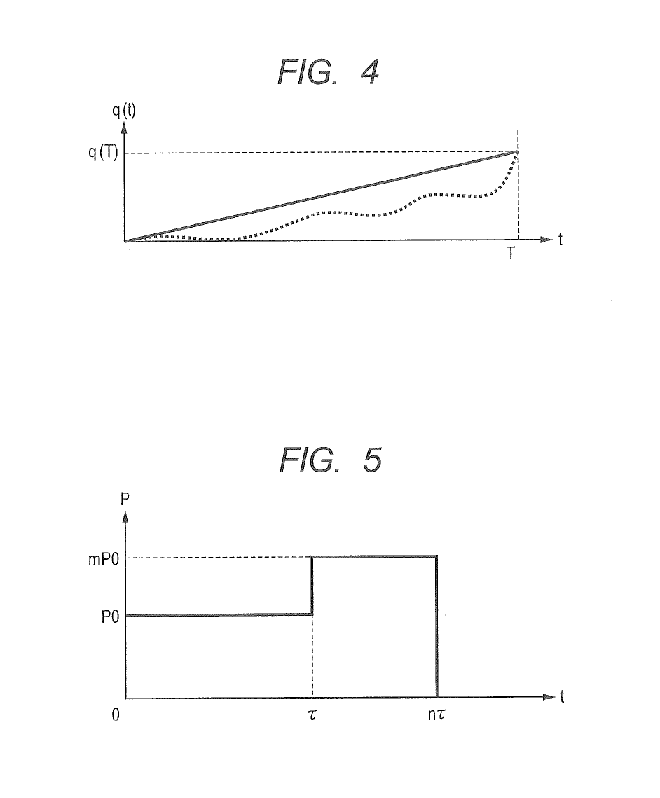

FIG. 4 is a graph expressing time fluctuations of the clock count q(t) Since a conventional DVFS control is performed so that the frequency becomes constant, q(t) becomes a proportional function of t as indicated by the broken line of FIG. 4, that is, the relation of q(t)=f0·t. On the other hand, in the case of performing optimization using the above-described algorithm, although the clock count q(t) matches the clock count q(0)=0 at the start point t=0 and the clock count q(T) at the endpoint t=T, the locus does not always become a straight line as indicated by the solid line in FIG. 4. q(t) indicating the relation between the clock count q and the time t is understood from (q, f) obtained in step S5. That is, when q=1, t=1/f1. When q=2, t=1/f1+1/f2. When q=j, time tj′ is tj′=Σ(1/fm), that is, a sum of 1/fm from m=1 to j. When q=N at the end point, that is, when j=N, it is a sum of 1/fm from m=1 to N. By determining the constant k as described above, tN′=tN. As q(t), (q, t)=(1, t1′), (2, t2′), . . . (N, tN′) is obtained.

The effect of the consumption energy reduction in the case of performing optimization using the above-described algorithm will be described by being quantified. To simplify calculation of quantification, the power profile P(t) is assumed as illustrated in FIG. 5. Time at which a process as a DVFS control target is executed is set from time 0 to nτ, the consumption power P from the time 0 to τ is constant at P0, and the consumption power P from the time τ to nτ is constant at mP0. m and n are arbitrary positive real numbers.

At this time, when consumption energy by the DVFS control based on the Euler equation solution of Equation 8 is set as A and consumption energy by the DVFS control at predetermined frequency is set as B, the ratio of the consumption energies is calculated by using the following equation 10.

$$\frac{A}{B} = \frac{{( ( n - 1 ) \cdot {m}^{1 / 3} + 1 )}^{3}}{( 1 + m \cdot ( n - 1 ) \cdot {n}^{2} )} \qquad Equation 10$$

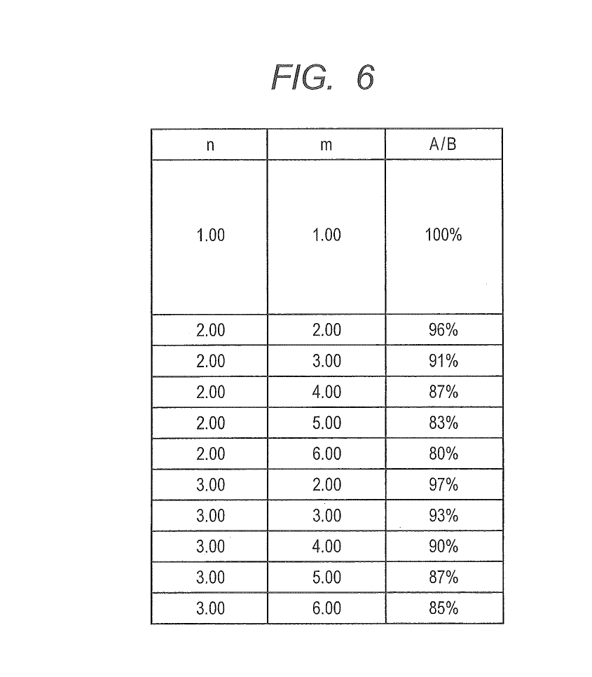

FIG. 6 illustrates values of the ratio A/B for the values of m and n, calculated by using Equation 10. As illustrated in FIG. 6, by executing the DVFS control based on the Euler equation solution of Equation 8, the consumption energy can be reduced as compared to the consumption energy of the conventional DVFS control executed at predetermined frequency.

Although it is not essential, the correcting process S6 illustrated in FIG. 1 may be executed after the step S5. There is a case that, depending on design of hardware, a clock supply circuit and a power supply circuit cannot change V(q) and f(q) instantaneously cycle by cycle. In this case, to decrease the number of changes in the operating voltage and/or the operating frequency of control data, it is desirable to execute the correcting process S6 of correcting the control data. A thinning process S6 for the functions (V(q), f(q)) as control data will be described here. In the case where time to cannot allow only a change of, for example, every 100 μs interval due to the limit of the power of the clock supply circuit and the power supply circuit, the functions (V(q), f(q)) are corrected so that the values of the functions (V(q), f(q)) change every time 100 μs.

Concretely, first, q(t) is calculated from (q, f) obtained in step S5. As described above, the relation of (q, t) is calculated and, as control data, N pieces of data (q, f, V, t)=(1, f1, V1, t1′), (2, f2, V2, t2′), . . . (tN, fN, VN, tN′) to which time is added are obtained.

Subsequently, the N pieces of data are sampled every time ta on the basis of the information at the time t. For example, control data (q, f, V)=(s1, fs1, Vs1) for the first time exceeding the time ta from the time 0 as the start point is extracted. Control data (s2, fs2, Vs2) for the first time exceeding time 2·ta from the time 0 is extracted. The extraction is repeated every time tN′ like time 3·ta, time 4·ta, . . . until the time reaches time tN′, so that the control data is reduced to sn pieces of control data (s1, fs1, Vs1), (s2, fs2, Vs2), (s3, fs3, Vs3), . . . , and (sn, fsn, Vsn). sn becomes the maximum integer which does not exceed tN/ta. The sn pieces of control data are generated as control data (4) to be obtained.

Before determination of the control data (4), consumption power may be calculated on the basis of the sn pieces of control data. In the case where the calculated consumption power becomes larger than consumption power by the power profile (2) obtained in step S1, the thinning process may be executed again at samplings every time longer than the time ta. When it is verified that consumption power calculated on the basis of sampling data as a result of re-execution becomes smaller than the consumption power by the power profile (2), the data is set as the control data (4).

### Method of Designing Semiconductor Device

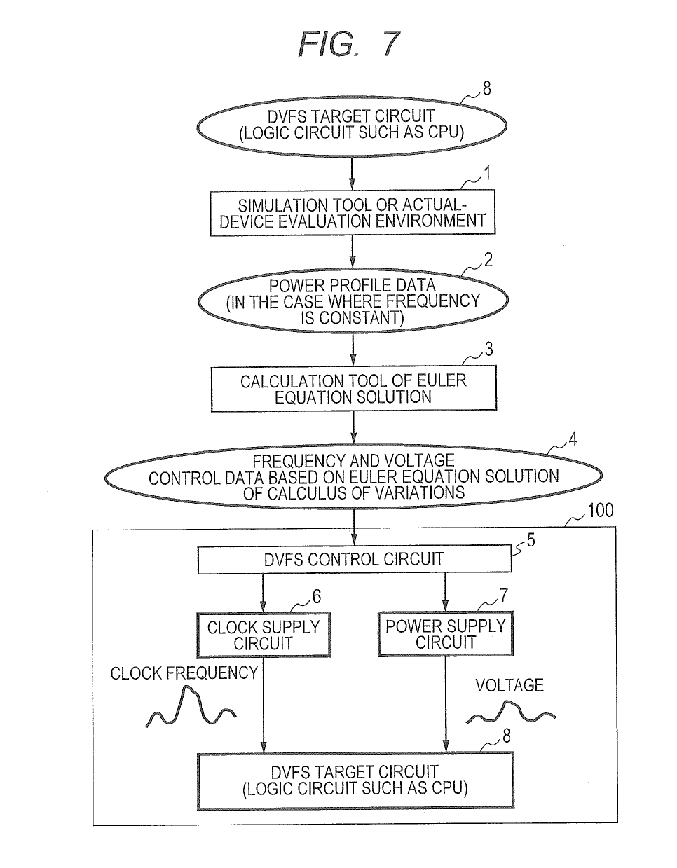

FIG. 7 is an explanatory diagram expressing an example of a method of designing a semiconductor device to which the algorithm of the embodiment is applied.

First, by a simulation tool for the DVFS target circuit 8 (logic circuit such as a CPU) or an actual device evaluation environment 1, power profile information 2 is obtained. The power profile information 2 is, for example, time fluctuation data P(t) of consumption power in the case of giving a clock of predetermined frequency and predetermined operating frequency to the DVFS target circuit 8 to make a DVFS target process executed. From the viewpoint of the algorithm, it is sufficient that a frequency and an operating voltage are known ones and do not have to be always made constant. It is, however, preferable not to make calculation at the post stage unnecessarily complicated by making the frequency and the operating voltage constant.

By using the data of the obtained power profile information 2, frequency/voltage control data 4 based on the Euler equation solution according to the calculus of variations is obtained by a calculation tool 3 of the Euler equation solution. According to the value of the control data 4, a DVFS control circuit 5 controls a clock supply circuit 6 and a power supply circuit 7. The clock supply circuit 6 supplies a clock having the designated frequency according to a frequency control instruction from the DVFS control circuit 5 to the DVFS target circuit 8. The power supply circuit 7 supplies a power of a designated voltage according to a voltage control instruction from the control circuit 5 to the DVFS target circuit 8.

The calculation tool 3 of the Euler equation solution is realized by executing a program by a computer and operates like the algorithm described with reference to FIG. 1. From the power profile information 2 obtained, the power profile P(t) is rewritten to the function P(q) related to the clock cycle q(t). Also with respect to the load capacity C and the leak power L, using the equation 4, the load capacity function C(q) and the leak power function L(Q) related to the cock cycle q(t) are obtained from the power profile information P(q). Next, by substituting Equation 4 into Equation 6 as an Euler equation, q(t) as a solution of the Euler equation solution according to an according to a solution of the variations is obtained, and control data 4 of the operating frequency f(q) and the operating voltage V(q) can be obtained from the obtained q(t).

In the control data 4, an optimum operating frequency and an optimum operating voltage can be specified every clock cycle. By finely controlling the operating frequency and the operating voltage cycle by cycle, the consumption energy E (an integration value of the consumption power P) necessary for the process as a target of the DVFS control can be theoretically suppressed to the minimum value. In practice, in place of fine control of every cycle, by changing the operating frequency and the operating voltage in a stair shape every proper cycle, the process can be executed with low consumption energy approximated to an ideal state. It is sufficient to switch the “proper cycle” at a proper timing to decrease an error as much as possible while satisfying a restriction of time at which the target process is to be completed at the time of approximating an ideal curve of the control data 4 by a stair-shaped control. In the case of executing the conventional DVFS control, a method of switching the proper cycle step by step by a designer is employed. However, there is not guarantee that this is a proper unit for minimizing the consumption energy. On the other hand, by determining the unit of a range on the basis of a consumption power profile obtained in reality, an optimum control for minimizing the consumption energy can be realized.

### Second Embodiment

### Processor for Including Control Data into Program

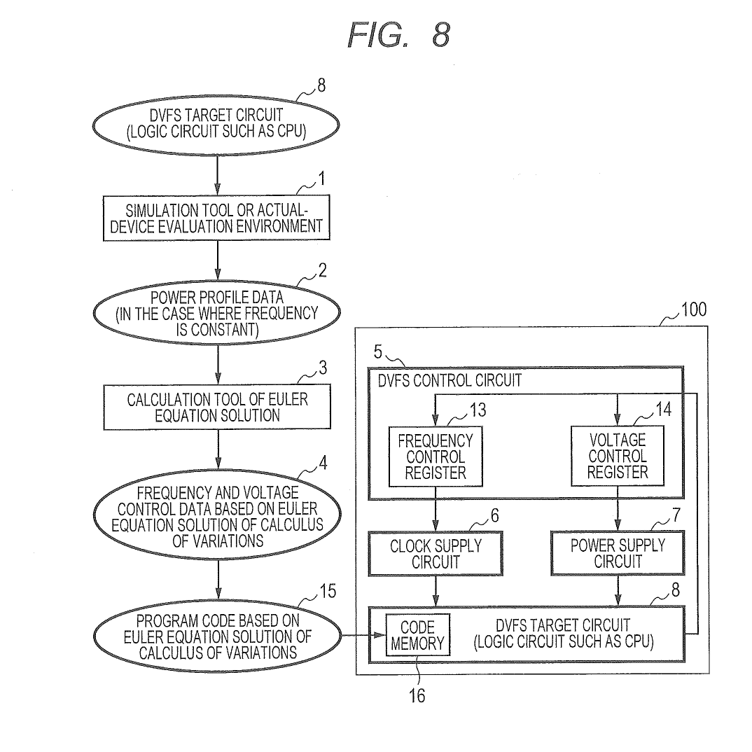

FIG. 8 is an explanatory diagram expressing an example of applying a method of designing a semiconductor device according to a second embodiment.

A semiconductor device 100 is configured by having the DVFS control target circuit 8, the DVFS control circuit 5, the clock supply circuit 6, and the power supply circuit 7. The DVFS control circuit 5 has a frequency control register 13 and a voltage control register 14. To the DVFS control target circuit 8, the clock supply circuit 6 supplies an operation clock of a frequency designated by the frequency control register 13 and the power supply circuit 7 supplies power of an operating voltage designated by the voltage control register 14. The DVFS control target circuit 8 has a processor such as a CPU (Central Processing Unit) or the like having a code memory 16 in which a program is stored, and can write data to the frequency control register 13 and the voltage control register 14. For example, the DVFS control circuit 5 is one of peripheral circuit modules coupled to the bus of the processor provided in the DVFS control target circuit 8, and the frequency control register 13 and the voltage control register 14 are address-mapped in the memory space of the processor. The processor can access the frequency control register 13 and the voltage control register 14 by a load/store instruction to the memory. Although not limited, the semiconductor device 100 is formed, for example, on a single semiconductor substrate such as silicon by using a known CMOS LSI (Large Scale Integrated circuit) manufacturing technique.

In the method of designing the semiconductor device 100 according to the second embodiment, in a manner similar to the embodiment illustrated in FIG. 7, by a simulation tool for the DVFS target circuit 8 or the actual device evaluation environment 1, the power profile information 2 is obtained. At this time, a program stored in the code memory 16 is executed by the processor of the DVFS target circuit 8 at a predetermined clock frequency. Using the data of the power profile information 2 obtained, by the calculation tool 3 of the Euler equation solution, the frequency/voltage control data 4 based on the Euler equation solution is obtained. In the embodiment, further, a program code 15 based on the Euler equation solution according to the calculus of variations is generated from the control data 4.

Since an operating frequency and an operating voltage which are optimum are specified for each of clock cycles in the frequency/voltage control data 4, they are approximated by a proper stair-like control to obtain a clock cycle which changes the operating frequency and the operating voltage. To execute a DVFS target process, in a program code, to a program step of executing the clock cycle calculated in the above, an instruction of writing data designating the operating frequency and the operating voltage obtained from the control data 4 into the frequency control register 13 and the voltage control register 14 is added. The generated program code 15 is stored in the code memory 16. The code memory 16 is provided, for example, in the DVFS target circuit 8 and may be configured as a non-volatile memory (ROM: Read Only Memory) in which the program code is stored in advance. Alternately, the code memory 16 may be configured as a volatile RAM (Random Access Memory) which is provided in the DVFS target circuit 8, and the program code 15 may be transferred from the outside by a boot process or the like and written.

The execution procedure of the second embodiment will be described.

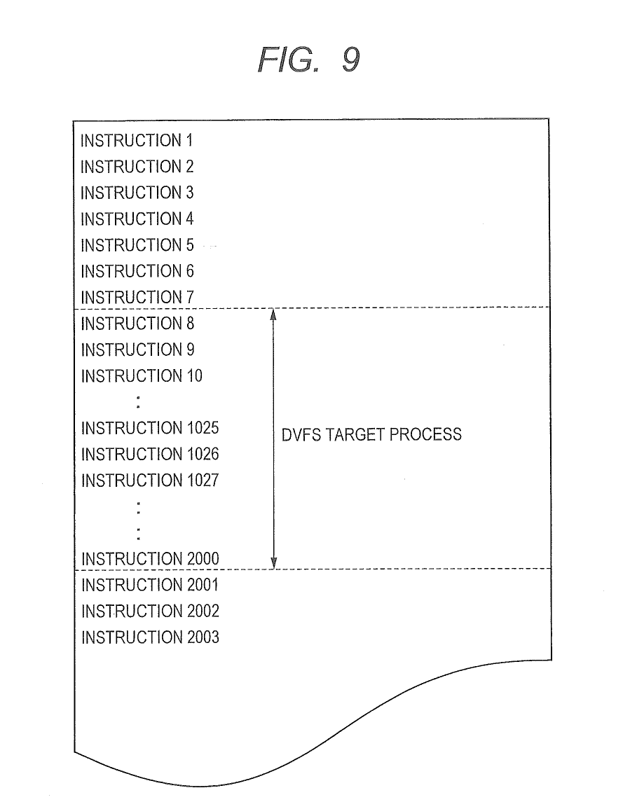

FIG. 9 is an explanatory diagram expressing an example of a program before the control data 4 is included. A program executed by a processor included in the DVFS control target circuit 8 is schematically illustrated. It is assumed that instructions 8 to 2000 are processes as a target of the DVFS control. The consumption power profile when the program is executed by the processor in the DVFS control target circuit 8 is obtained by using a simulation tool or the actual device evaluation environment 1.

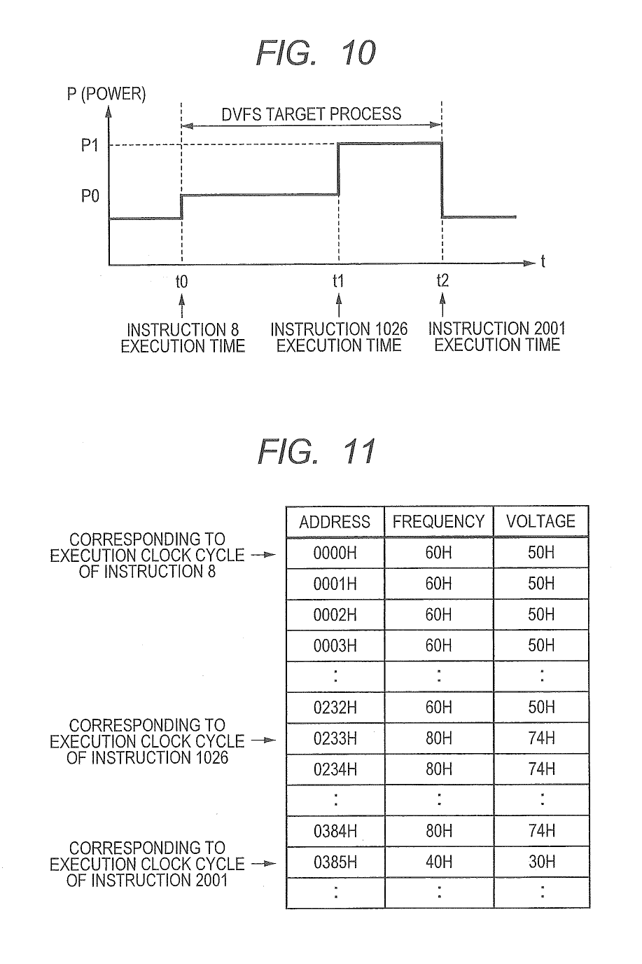

FIG. 10 is a schematic waveform chart expressing an example of the power profile 2 obtained. Times t0, t1, and t2 are set as times at which the instructions 8, 1026, and 2001 are executed, respectively. The period from time t0 to time t2 is a period in which the DVFS target process is executed in the program illustrated in FIG. 9. In the power profile 2 illustrated in FIG. 10, the consumption power from time t0 to time t1 is expressed as P0, and the consumption power from time t1 to time t2 is expressed as P1. Description will be given on assumption that the time at which the power changes is only the time t1 in the period of the DVFS target process in the example of the power profile of FIG. 10.

By using the calculation tool 3 of the Euler equation solution from the power profile data 2 illustrated in FIG. 10 in accordance with the procedure illustrated in FIG. 8, the frequency and the voltage control data 4 based on the Euler equation solution according to the calculus of variations is obtained. FIG. 11 is a table expressing an example of the calculated control data 4. An address written in the column of address expresses the number of clock cycles since the DVFS target process has started. The character “H” at the end of each data indicates that the data has a hexadecimal value. The address 0000H corresponds to the clock cycle of executing the instruction 8. Similarly, the address 0233H corresponds to the clock cycle of executing the instruction 1026. The address 0385H corresponds to the clock cycle of executing the instruction 2001. In the frequency and voltage columns, data to be set in the frequency control register 13 and the voltage control register 14 in each address, that is, the execution cycle of the number of clock cycles since the DVFS target process has started is indicated. Data 60H is set in the frequency control register 13 and data 50H is set in the voltage control register 14 in the period from the address 0000H to the address 0232H and data 80H is set in the frequency control register 13 and 74H is set in the voltage control register 14 in the period from the address 0233H to the address 0384H. By the setting, the operating frequency and the operating voltage are controlled on the basis of the Euler equation solution, and the consumption energy E required for the DVFS target process is minimized.

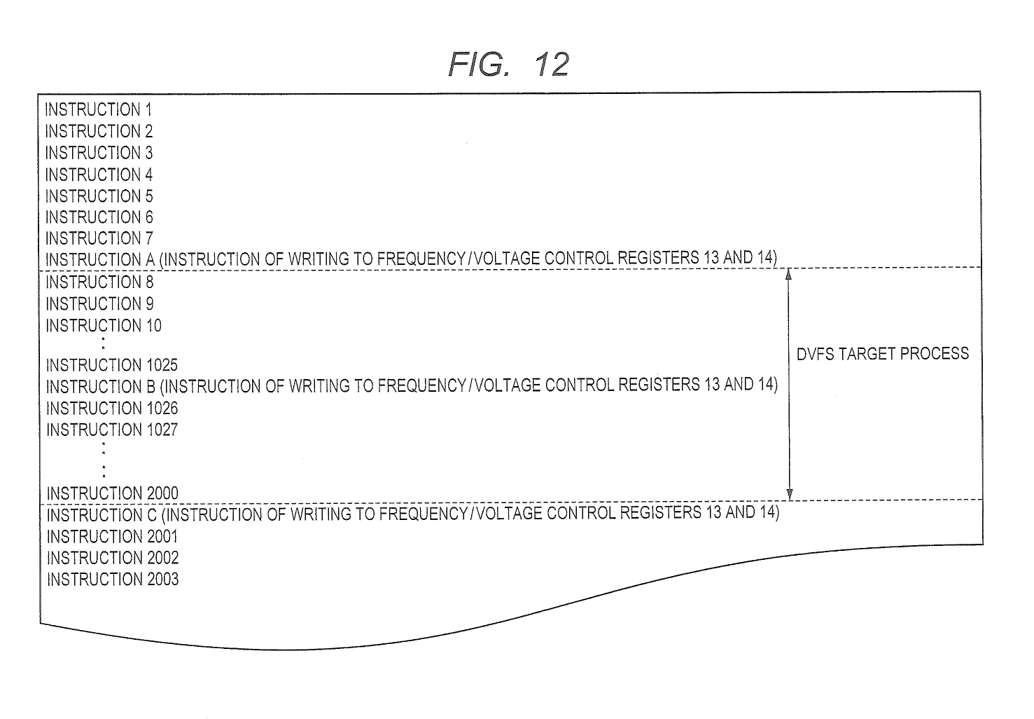

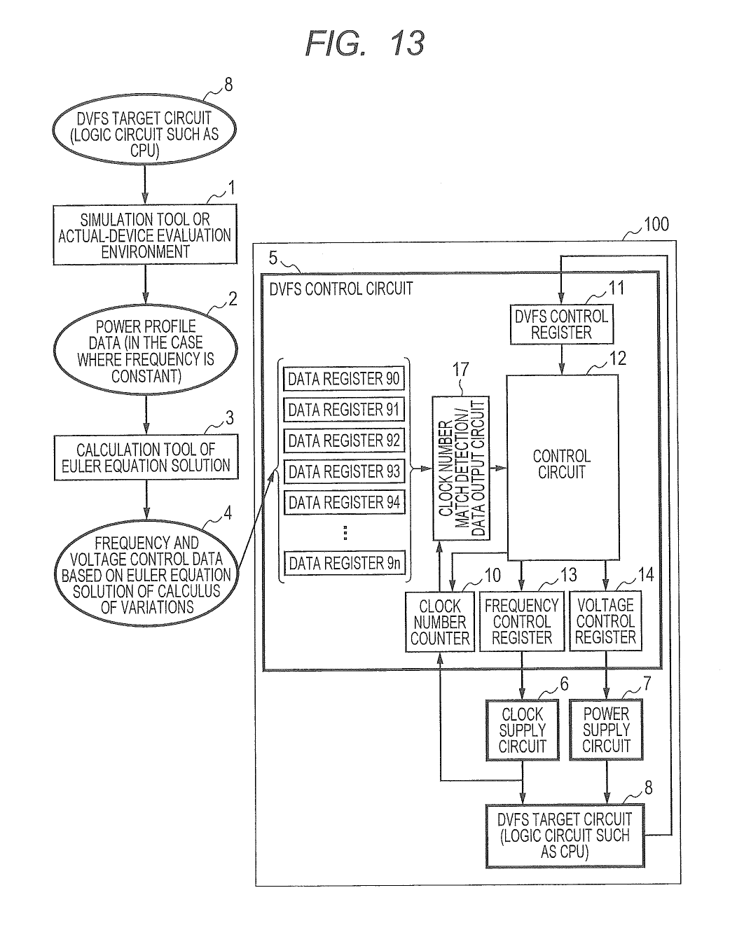

The program code 15 based on the Euler equation solution according to the calculus of variations generated on the basis of the frequency and voltage control data 4 will be described. FIG. 12 is an explanatory diagram expressing an example of a program after the control data 4 is included. Into a program before the control data 4 illustrated in FIG. 9 is included, an instruction necessary for the DVFS control is inserted. First, the instruction A is inserted just before the instruction 8 at which the DVFS control starts. The instruction A is an instruction of writing to the frequency control register 13 and the voltage control register 14, and write data is 60H and 50H as the data in the address 0000H in FIG. 11. Subsequently, the frequency and the voltage have to be changed in the address 0233H according to the control data of FIG. 11, so that the instruction executed in the address 0233H is obtained. It is demanded that the instruction executed in the address 0233H is the instruction 1026, and the instruction B is inserted just before the instruction 1026. The instruction B is an instruction of writing to the frequency control register 13 and the voltage control register 14, and write data is 80H and 74H as the data in the address 0233H in FIG. 11. Finally, the instruction C is inserted immediately after the instruction 2000 in which the DVFS control is finished. The instruction C is an instruction of writing to the frequency control register 13 and the voltage control register 14, and write data is 40H and 30H as the data in the address 0385H in FIG. 11. Initial values to be written in the frequency control register 13 and the voltage control register 14 when the DVFS control is not performed are assumed to be 40H and 30H, respectively.

As described above, to perform the DVFS control based on the Euler equation solution according to the calculus of variations, the program code 15 after the control data 4 is entered is stored in the code memory 16.

The operation performed when the DVFS target circuit 8 executes the content in the code memory 16 will be described. It is assumed that, first, the initial value 40H is written in the frequency control register 13 and the initial value 30H is written in the voltage control register 14. In this state, the DVFS target circuit 8 sequentially executes the instructions of the program illustrated in FIG. 12 from the instruction 1. The DVFS target circuit 8 executes the instruction A inserted after the instruction 7 as described above. By the execution of the instruction A, 60H and 50H is written in the frequency control register 13 and the voltage control register 14, respectively. Accordingly, the clock supply circuit 6 supplies the clock of the frequency designated by the value in the frequency control register 13 to the DVFS target circuit 8. The power supply circuit 7 supplies the power of the voltage designated by the value of the voltage control register 14 to the DVFS target circuit 8.

After that, the DVFS target circuit 8 sequentially executes the instruction 8 and the subsequent instructions and executes the instruction B after the instruction 1025. By execution of the instruction B, 80H and 74H are written in the frequency control register 13 and the voltage control register 14, respectively. Accordingly, the clock supply circuit 6 supplies the clock of the frequency designated by the value of the frequency control register 13 to the DVFS target circuit 8. The power supply circuit 7 supplies the power of the voltage designated by the value of the voltage control register 14 to the DVFS target circuit 8.

After that, the DVFS target circuit 8 sequentially executes the instruction 1026 and the subsequent instructions and executes the instruction C after the instruction 2000. By execution of the instruction C, 40H and 30H are written in the frequency control register 13 and the voltage control register 14, respectively. Accordingly, the clock supply circuit 6 supplies the clock having the frequency designated by the value of the frequency control register 13 to the DVFS target circuit 8. The power supply circuit 7 supplies the power of the voltage designated by the value of the voltage control register 14 to the DVFS target circuit 8.

As described above, by employing the configuration capable of directly controlling the frequency control register 13 and the voltage control register 14 by the processor (CPU) in the DVFS target circuit 8 in the case where the frequency of changing the frequency and the voltage is low in the DVFS control, the circuit amount of the hardware configuring the DVFS control circuit 5 can be reduced.

### Third Embodiment

### Dedicated Hardware Holding Control Data in Storing Device

FIG. 13 is an explanatory diagram expressing an example of applying a method of designing a semiconductor device according to a third embodiment.

In a method of designing the semiconductor device 100 according to the third embodiment, in a manner similar to the embodiment illustrated in FIG. 7, the power profile information 2 is obtained by a simulation tool for the DVFS target circuit 8 or the actual device evaluation environment 1. At this time, a program stored in the code memory 16 is executed by the processor of the DVFS target circuit 8 at a predetermined clock frequency. Using the data of the power profile information 2 obtained, by the calculation tool 3 of the Euler equation solution, the frequency/voltage control data 4 based on the Euler equation solution is obtained. Since the operating frequency and the operating voltage optimum for each of the clock cycles are specified in the frequency/voltage control data 4, they are approximated by a proper stair-like control to obtain a clock cycle which changes the operating frequency and the operating voltage.

The semiconductor device 100 includes the DVFS control target circuit 8, the DVFS control circuit 5, the clock supply circuit 6, and the power supply circuit 7. The DVFS control circuit 5 has the frequency control register 13, the voltage control register 14, a control circuit 12, a DVFS control register 11, a clock number counter 10, data registers 90 to 9n, and a clock number match detection/data output circuit 17. For the DVFS control target circuit 8, the clock supply circuit 6 supplies an operation clock having a frequency designated by the frequency control register 13, and the power supply circuit 7 supplies the power of an operating voltage designated by the voltage control register 14.

In the DVFS control circuit 5, main data in the control data 4 is stored with a set of a clock count value, and the operating frequency and the operating voltage at that time, into the data registers 90 to 9n. The clock signals supplied from the clock supply circuit 6 to the DVFS target circuit 8 are counted by the clock number counter 10. Although not illustrated, the clock number counter 10 is initialized (reset) at the time point when the DVFS target process is started. The clock number match detection/data output circuit 17 compares the number of clocks output from the clock number counter 10 and the clock count value stored in the data registers 90 to 9n, when the numbers match, outputs the corresponding operating frequency and operating voltage to the control circuit 12, and writes them into the frequency control register 13 and the voltage control register 14 via the control circuit 12. The DVFS control register 11 is a register storing a start bit for starting the DVFS control. When the DVFS target circuit 8 sets the start bit, the control circuit 12 starts the DVFS control.

The execution procedure of the third embodiment will be described.

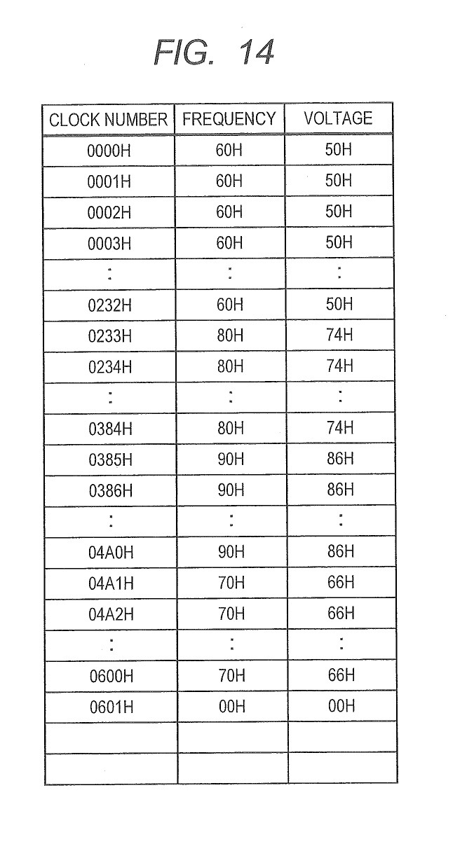

By using the calculation tool 3 of the Euler equation solution from the power profile data 2 in accordance with the procedure illustrated in FIG. 13, the frequency and the voltage control data 4 based on the Euler equation solution according to the calculus of variations is obtained. FIG. 14 is a table expressing an example of the calculated control data 4. An address written in the column of address expresses the number of clock cycles since the DVFS target process has started. To simplify the description, an example that the control data 4 changes in a stair shape with respect to the number of clocks is illustrated. The control data 4 illustrated in FIG. 14 may specify the relation between the operating frequency and the operating voltage for the number of clocks, obtained by being approximated in a stair-like shape from the frequency/voltage control data based on the Euler equation solution obtained by the calculation tool 3 of the Euler equation solution.

The address 0000H corresponds to the start time of the DVFS control. In the period from the clock number 0000H to 0232H, the data of the frequency remains 60H and the data of the voltage remains 50H. In the clock number 0233H, the frequency data changes to 80H and the voltage data changes to 74H and, after that, 80H and 74H are unchanged through 0384H. In the clock number 0385H, the frequency data changes to 90H and the voltage data changes to 86H and, after that, 90H and 86H are unchanged through 04A0H. In the clock number 04A1H, the frequency data changes to 70H and the voltage data changes to 66H and, after that, 70H and 66H are unchanged through 0600H. In the clock number 0601H, the DVFS control is finished.

Data of change points of the control data 4 illustrated in the table of FIG. 14 is sequentially stored in the data registers 90 to 94 by an operation before the DVFS control for the DVFS target circuit 8 is started. For example, the data of the change points of the control data 4 is stored in advance in a nonvolatile memory and, by a power-on reset or an initialization routine at the time of power on, can be sequentially transferred to the data registers 90 to 94. Concretely, data of (clock number/frequency/voltage)=(0000H, 60H, 50H) in FIG. 14 is stored in the data register 90. Data of (clock number/frequency/voltage)=(0233H, 80H, 74H) is stored in the data register 91. Data of (clock number/frequency/voltage)=(0385H, 90H, 86H) is stored in the data register 92. Data of (clock number/frequency/voltage)=(04A1H, 70H, 66H) is stored in the data register 93. Finally, data of (clock number/frequency/voltage)=(0601H, 00H, 00H) at the DVFS control end point is stored in the data register 94.

Next, with reference to FIG. 13, the operation of the semiconductor device 100 according to the third embodiment will be described.

Since the DVFS control is not started in the beginning, standard initial values are set in the frequency control register 13 and the voltage control register 14 and, according to the values, the clock supply circuit 6 and the power supply circuit 7 supply the clock and the power supply voltage to the DVFS target circuit 8. When the DVFS target circuit 8 sets the start bit of the DVFS control register 11, the control circuit 12 starts the operation. The control circuit 12 starts the clock number counting operation of the clock number counter 10. After that, when the DVFS control is started, the initial value of the clock number counter 10 becomes 0000H. Consequently, the clock number match detection/data output circuit 17 detects a match between the clock number 0000H stored in the data register 90 and the clock count value of the clock number counter 10, and transfers the data of the corresponding frequency and voltage stored in the data register 90 to the control circuit 12. The control circuit 12 sets the data of the received frequency and the voltage to the frequency control register 13 and the voltage control register 14, respectively. The clock supply circuit 6 supplies a clock having the designated frequency to the DVFS target circuit 8 in accordance with the value of the frequency control register 13. The power supply circuit 7 supplies the power of the designated voltage to the DVFS target circuit 8 in accordance with the value of the voltage control register 14.

After that, the value of the clock number counter 10 sequentially increases from 0000H. When the value of the clock number counter 10 becomes 0233H, the clock number match detection/data output circuit 17 detects a match between the clock number 0233H stored in the data register 91 and the value of the clock number counter 10, and transfers the data of the corresponding frequency and voltage stored in the data register 91 to the control circuit 12. The control circuit 12 sets the data of the received frequency and the voltage to the frequency control register 13 and the voltage control register 14, respectively. The clock supply circuit 6 supplies a clock having the designated frequency to the DVFS target circuit 8 in accordance with the value of the frequency control register 13. The power supply circuit 7 supplies the power of the designated voltage to the DVFS target circuit 8 in accordance with the value of the voltage control register 14.

After that, the value of the clock number counter 10 sequentially increases. When the value of the clock number counter 10 becomes 0385H, the clock number match detection/data output circuit 17 detects a match between the clock number 0385H stored in the data register 92 and the value of the clock number counter 10, and transfers the data of the corresponding frequency and voltage stored in the data register 92 to the control circuit 12. The control circuit 12 sets the data of the received frequency and the voltage to the frequency control register 13 and the voltage control register 14, respectively. The clock supply circuit 6 supplies a clock having the designated frequency to the DVFS target circuit 8 in accordance with the value of the frequency control register 13. The power supply circuit 7 supplies the power of the designated voltage to the DVFS target circuit 8 in accordance with the value of the voltage control register 14.

After that, the value of the clock number counter 10 sequentially increases. When the value of the clock number counter 10 becomes 04A1H, the clock number match detection/data output circuit 17 detects a match between the clock number 04A1H stored in the data register 93 and the value of the clock number counter 10, and transfers the data of the corresponding frequency and voltage stored in the data register 93 to the control circuit 12. The control circuit 12 sets the data of the received frequency and the voltage to the frequency control register 13 and the voltage control register 14, respectively. The clock supply circuit 6 supplies a clock having the designated frequency to the DVFS target circuit 8 in accordance with the value of the frequency control register 13. The power supply circuit 7 supplies the power of the designated voltage to the DVFS target circuit 8 in accordance with the value of the voltage control register 14.

After that, the value of the clock number counter 10 sequentially increases. When the value of the clock number counter 10 becomes 0601H, the clock number match detection/data output circuit 17 detects a match between the clock number 0601H stored in the data register 94 and the value of the clock number counter 10, and transfers the data of the corresponding frequency and voltage stored in the data register 94 to the control circuit 12. The data of the frequency and the voltage at this time is 0000H. When the data 0000H is received, the control circuit 12 detects that the DVFS control is finished, and sets standard initial values in the frequency control register 13 and the voltage control register 14. Similarly, the control circuit 12 clears the start bit in the DVFS control register 11 and the value of the clock number counter 10.

As described above, by providing the DVFS control circuit 5 with the clock number counter 10, the data registers 90 to 9n, the clock number match detection/data output circuit 17, and the control circuit 12, without modifying the program given to the processor (CPU) of the DVFS target circuit 8, the DVFS control based on the frequency and voltage control data 4 based on the Euler equation solution according to the calculus of variations can be performed. Further, also in the case where the DVFS target circuit 8 is dedicated hardware having no processor or a special processor which does not allow modification of a program, similarly, the DVFS control based on the frequency and voltage control data 4 based on the Euler equation solution according to the calculus of variations can be performed.

### Fourth Embodiment

### Control Data Every One Cycle

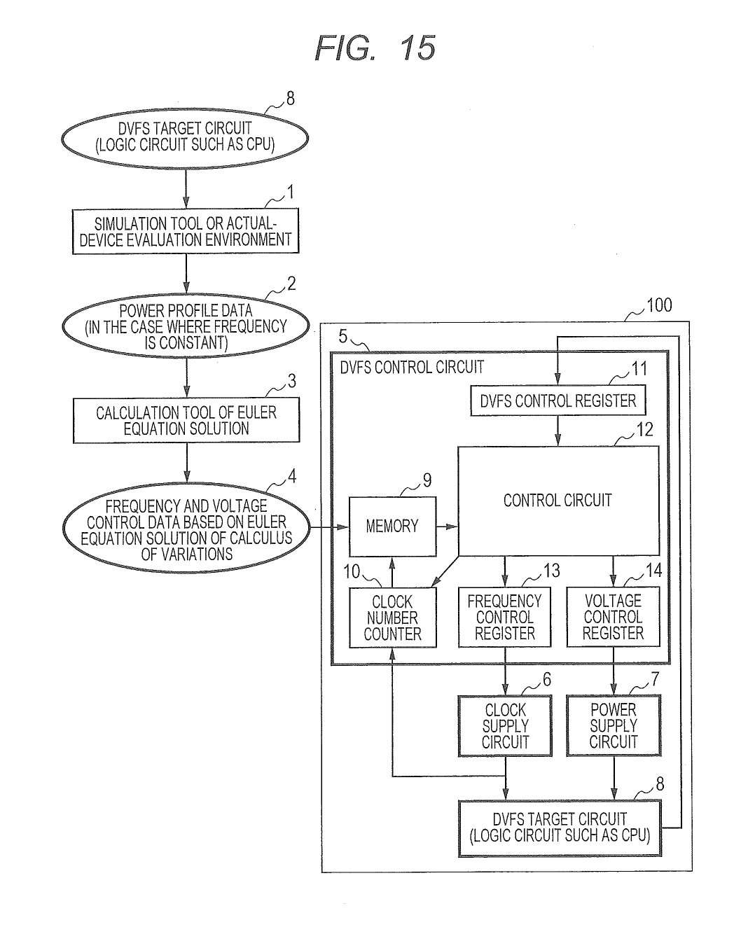

FIG. 15 is an explanatory diagram expressing an example of applying a method of designing a semiconductor device according to a fourth embodiment.

In the method of designing the semiconductor device 100 according to the fourth embodiment, in a manner similar to the embodiment illustrated in FIG. 7, the power profile information 2 is obtained by a simulation tool for the DVFS target circuit 8 or the actual device evaluation environment 1. At this time, a program stored in the code memory 16 is executed by the processor of the DVFS target circuit 8 at a predetermined clock frequency. Using the data of the power profile information 2 obtained, by the calculation tool 3 of the Euler equation solution, the frequency/voltage control data 4 based on the Euler equation solution is obtained. The operating frequency and the operating voltage optimum for each of the clock cycles are specified in the frequency/voltage control data 4. Although an example of approximating the data to a stair-like control has been described in the second and third embodiments, in the fourth embodiment, by controlling the operating frequency and the operating voltage cycle by cycle using the control data 4 of every cycle, an optimum DVFS control is realized.

The semiconductor device 100 includes the DVFS control target circuit 8, the DVFS control circuit 5, the clock supply circuit 6, and the power supply circuit 7. The DVFS control circuit 5 has the frequency control register 13, the voltage control register 14, the control circuit 12, the DVFS control register 11, the clock number counter 10, and a memory 9. For the DVFS control target circuit 8, the clock supply circuit 6 supplies an operation clock having a frequency designated by the frequency control register 13, and the power supply circuit 7 supplies the power of an operating voltage designated by the voltage control register 14.

In the DVFS control circuit 5, the control data 4 is stored in the memory 9. For example, using each of the cycles obtained by the Euler equation solution as an address in the memory 9, the frequency/voltage control data 4 corresponding to the address is stored. The clock number counter 10 is a counter for counting the number of clocks supplied from the clock supply circuit 6 to the DVFS target circuit 8. The value of the clock number counter 10 is input to an address in the memory 9 and corresponding frequency/voltage control data 4 is read. The read frequency/voltage control data 4 is written in each of the frequency control register 13 and the voltage control register 14 via the control circuit 12. The DVFS control register 11 is a register storing a start bit for starting the DVFS control. When the DVFS target circuit 8 sets the start bit, the control circuit 12 starts the DVFS control.

The execution procedure of the fourth embodiment will be described.

By using the calculation tool 3 of the Euler equation solution from the power profile data 2 in accordance with the procedure illustrated in FIG. 15, the frequency and the voltage control data 4 based on the Euler equation solution according to the calculus of variations is obtained.

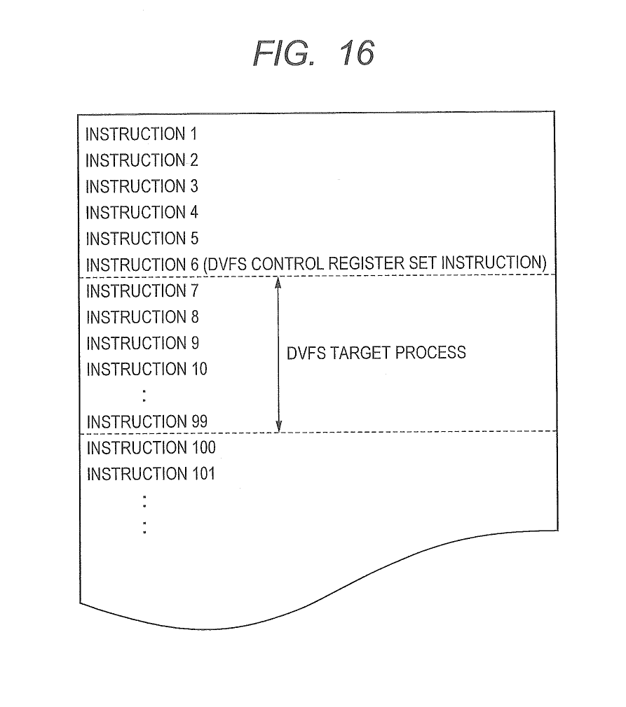

FIG. 16 is an explanatory diagram expressing an example of a program executed by the DVFS control target circuit (such as a CPU) 8. Instructions 7 to 99 are DVFS target processes and, by executing the instruction 6, the DVFS target circuit 8 sets the start bit. Ina simulation tool for the DVFS target circuit 8 or the actual device evaluation environment 1 illustrated in FIG. 15, by executing the instructions 7 to 99 as DVFS target processes, the power profile information 2 is obtained. Using the data of the obtained power profile information 2, the frequency/voltage control data 4 based on the Euler equation solution is obtained by the calculation tool 3 of the Euler equation solution.

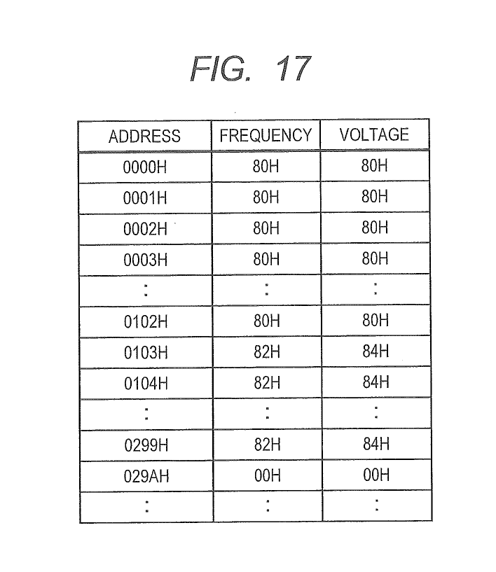

FIG. 17 is a table expressing an example of numerical values of the calculated control data 4 and a state in which the values are stored in the memory 9. When the instructions 7 to 99 as DVFS target processes are executed, the clock cycle advances from 0000H to 0299H, and the process returns to a process which is not the DVFS target in 029AH. The frequency/voltage control data 4 obtained in correspondence with the clock cycles 0000H to 0299H is stored in the addresses 0000H to 0299H in the memory 9. The frequency/voltage control data 4 corresponding to the clock cycles 0000H to 0102H is 80H and 80H, and the values are stored in the addresses 0000H to 0102H in the memory 9. The frequency/voltage control data 4 corresponding to the clock cycles 0103H to 0299H is 82H and 84H, the values are stored in the addresses 0103H to 0299H in the memory 9, and 00H and 00H are stored in the address 029AH and subsequent addresses. The memory 9 has, for example, a 16-bit width. Eight bits designating the operating frequency are stored in as upper bits, and eight bits designating the operating voltage are stored as lower bits. Consequently, when an address is designated in the memory 9, the control data 4 designating the frequency and voltage is simultaneously read. The numerical values expressed here are just an example, and possible values including the number of bits are arbitrary. Particularly, although an example that the frequency and voltage are constant within the range of certain clock cycles is illustrated in FIG. 17, they may change cycle by cycle. The memory 9 is mounted, for example, as a nonvolatile memory and the frequency/voltage control data 4 is written at the time of shipping. The control data 4 may be calculated individually for each product. In such a manner, the DVFS control optimized for each product can be performed.

Next, the actual DVFS control operation will be described.

First, the DVFS target circuit 8 is operated to sequentially execute instructions of the program illustrated in FIG. 16 from the instruction 1. Since the DVFS control is not started in the beginning, standard initial values are set in the frequency control register 13 and the voltage control register 14 and, according to the values, the clock supply circuit 6 and the power supply circuit 7 supply the clock and the power supply voltage to the DVFS target circuit 8. After that, the instructions are sequentially executed. When the instruction 6 is executed, the start bit in the DVFS control register 11 is set. When the start bit is set, the control circuit 12 starts the operation.

At this time, the control circuit 12 starts the clock number counting operation of the clock number counter 10. The clock number counter 10 sequentially counts the numbers of clocks supplied from the clock supply circuit 6. The control circuit 12 sequentially receives the content of the memory 9 corresponding to the address designated by the value of the clock value counter 10 and sequentially updates the values of the frequency control register 13 and the voltage control register 14. The clock supply circuit 6 supplies a clock having a designated frequency in accordance with the value of the frequency control register 13 to the DVFS target circuit 8. The power supply circuit 7 supplies the power of the designated voltage to the DVFS target circuit 8 in accordance with the value of the voltage control register 14.

Although the value of the clock number counter 10 sequentially increases from 0000H, when the DVFS target process is completed, the clock count becomes 029AH and the address 029AH in the memory 9 is accessed, the data 0000H is supplied from the memory 9 to the control circuit 12. On receipt of the data 0000H, the control circuit 12 detects completion of the DVFS control and sets standard initial values in the frequency control register 13 and the voltage control register 14. Similarly, the control circuit 12 clears the start bit of the DVFS control register 11 and the value of the clock value counter 10.

As described above, by providing the DVFS control circuit 5 with the clock number counter 10, the memory 9, and the control circuit 12, without modifying the program given to the processor (CPU) of the DVFS target circuit 8, the DVFS control based on the frequency and voltage control data 4 based on the Euler equation solution according to the calculus of variations can be performed. Since all of the frequency and voltage control data 4 based on the Euler equation solution according to the calculus of variations can be stored into the memory 9 cycle by cycle without approximating it, ideal DVFS control with theoretically minimized consumption energy can be performed. Further, also in the case where the DVFS target circuit 8 is dedicated hardware having no processor or a special processor which does not allow modification of a program, similarly, the DVFS control based on the frequency and voltage control data 4 based on the Euler equation solution according to the calculus of variations can be performed.

### Fifth Embodiment

### Plural CPUs

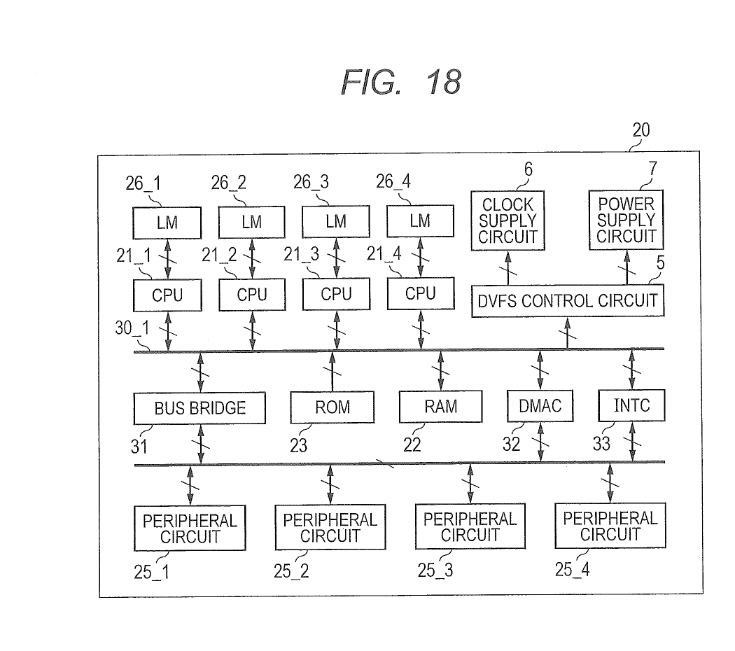

In the fifth embodiment, the case where a plurality of IPs (Intellectual Properties) which can operate in parallel exist in the DVFS target circuit 8 illustrated in FIG. 7 will be considered. FIG. 18 is a block diagram expressing a configuration example of a microcomputer 20 including the DVFS control target circuit 8 having a plurality of IPs. The method of designing the semiconductor device illustrated in FIG. 7 can be applied also to the DVFS control target circuit 8 and, for example, the calculation tool 3 of the Euler equation solution has the function of outputting consumption energy when the DVFS control based on the Euler equation solution is executed.

The microcomputer 20 includes the DVFS control circuit 5, the clock supply circuit 6, the power supply circuit 7, and the DVFS target circuit 8. A plurality of IPs are configured by, for example, CPUs 21-1, 21-2, 21-3, and 21-4 having local memories (LM) 26-1, 26-2, 26-3, and 26-4, respectively. The microcomputer 20 further includes a RAM 22, a ROM 23, a DMA control circuit 32, an interrupt control circuit 33, a bus bridge 31, and peripheral circuits 25_1 to 25_4. The plurality of CPUs 21_1 to 21_4 are coupled to the RAM 22, the ROM 23, the DMA control circuit 32, the interrupt control circuit 33, and the like via a bus 30_1. The bus 30_1 is coupled to a bus 30_2 via the bus bridge 31, and the peripheral circuits 25_1 to 25_4 and the like are coupled to the bus 30_2. The DVFS control circuit 5 is coupled to, for example, the bus 30_1, and may be coupled to the bus 30_2 like the peripheral circuits 25_1 to 25_4 and the like. The clock supply circuit 6 and the power supply circuit 7 supply the clock signal and power, respectively, to the DVFS target circuit 8. The entire microcomputer 20 may be regarded as the DVFS target circuit 8. Alternately, only the CPUs 21_1 to 21_4 and the local memories (LM) 26_1 to 26_4 may be regarded as the DVFS target circuit 8. In the ROM 23, a program to be executed by the CPUs 21_1 to 21_4 is stored. The CPUs 21_1 to 21_4 cache program codes necessary for assigned processes in their local memories (LM) 26_1 to 26_4 and execute them.

The configuration illustrated in FIG. 18 is just an example. A configuration that the CPUs having no local memories sequentially fetch instruction codes from the common ROM 23 and operate, or have individually program ROMs may be employed. The hierarchical structures of the buses and the memories are also arbitrary. The IP is not limited to the CPU. The IP may include a processor such as a DSP (Digital Signal Processor) capable of executing a program programmed by another instruction set, or may be dedicated hardware configured by a simple sequencer. The following description is based on a precondition that, like the configuration illustrated in FIG. 18, the plurality of IPs in the DVFS target circuit 8 are plurality of CPUs and a program stored in the ROM 23 can be executed by the plurality of CPUs.

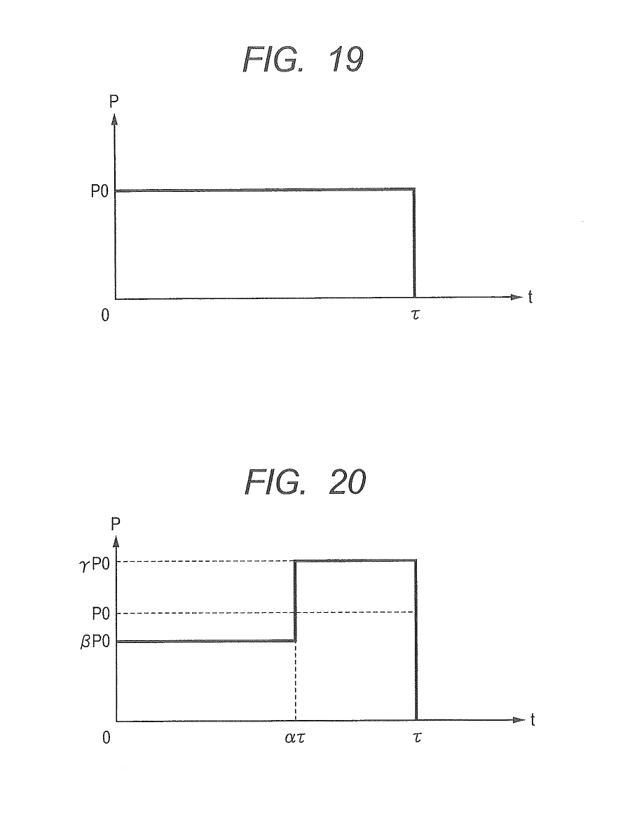

The execution procedure of the fifth embodiment will be described. First, a consumption power profile when the DVFS control target circuit 8 executes predetermined software is obtained by using a simulation tool or the actual device evaluation environment 1. FIG. 19 is a schematic waveform chart expressing an example of the power profile 2 before a software change. The consumption power P0 is constant from the time 0 to T. Since the DVFS target circuit 8 is configured by a plurality of IPs (such as CPUs) which can operate in parallel, it is assumed that the profile can be changed to the power profile data 2 as illustrated in FIG. 20 by increasing the parallel process by changing the software. α, β, and γ are positive real numbers and change according to the degree of parallelism of processes. In FIG. 20, the process is executed while decreasing the degree of parallelism so that the consumption power is suppressed to βP0 lower than P0 from the time 0 to ατ. From the time ατ to τ, the processes are performed while increasing the degree of parallelism so that the consumption power is set to γP0 higher than P0. In such a manner, execution of the same software is completed in the period from the time 0 to τ which is the same as illustrated in FIG. 19.

When it is assumed the consumption energy is unchanged before and after the change of the software, the following relational equation is satisfied.

P0·τ=βP0·ατ+γP0·(1−α)τ Equation 11

When the above equation is modified, the following relations are satisfied among α, β, and γ.

1=βα+γ(1−α) Equation 12

When the consumption energy in the case of executing the DVFS control based on the Euler equation solution on the power profile data 2 illustrated in FIG. 20 after the software change is set as A1 and the consumption energy in the case of executing the DVFS control on the power profile data 2 illustrated in FIG. 19 before the software change is set as B1, the value of A1/B1 is expressed as follows.

$$\frac{A 1}{B 1} = {( ( 1 - α ) \cdot {γ}^{1 / 3} + α \cdot {β}^{1 / 3} )}^{3} \qquad Equation 13$$

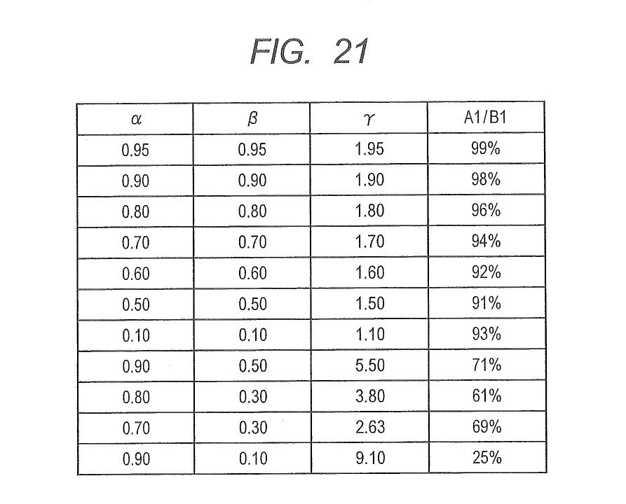

FIG. 21 is a table expressing an example of numerical values of an effect of reduction of consumption power in the case of adjusting the degree of parallelism. The values of A1/B1 calculated by substituting proper values α, β, and γ into Equation 13 are shown. It is understood that as the parallel process increases, the consumption power amount (energy) by the DVFS control according to the Euler equation decreases.

Therefore, in the case where the DVFS target circuit is configured by a plurality of circuits (such as CPUs) which can operate in parallel, by changing the software while feeding back power and consumption energy information obtained by using the calculation tool 3 of the Euler equation solution to increase the parallel processes as much as possible and then performing the DVFS control according to the Euler equation, the consumption power amount (energy) can be effectively reduced.

### Sixth Embodiment

### Application Example

Ina sixth embodiment, an application example of applying the method of designing the semiconductor device described in the first embodiment to a sensor microcomputer system of a circuit/control method will be described.

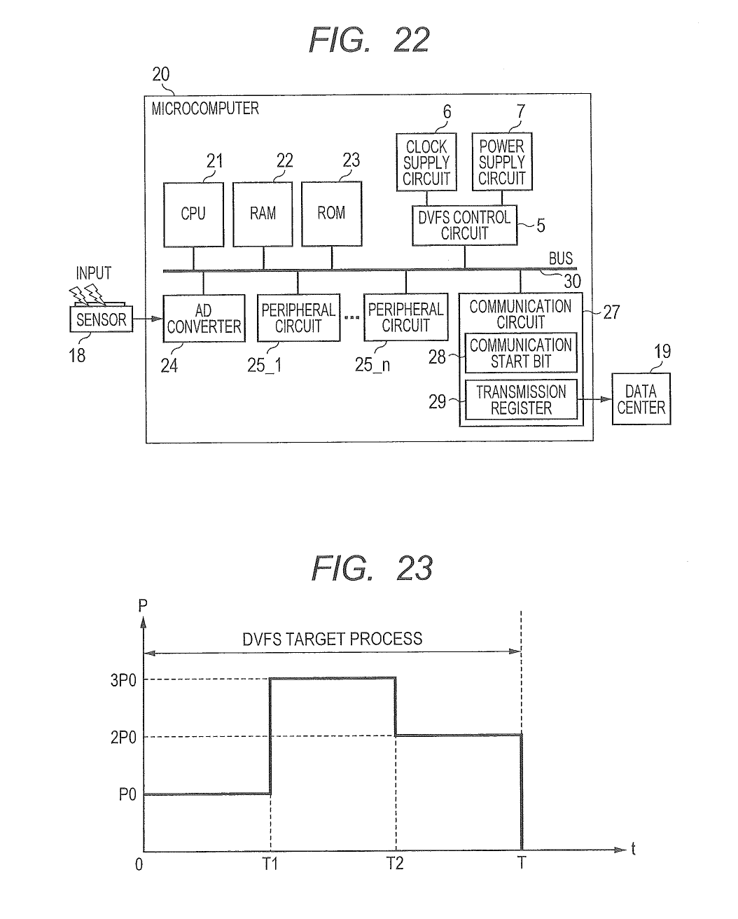

FIG. 22 is a block diagram expressing an example of the configuration of the microcomputer 20 according to the sixth embodiment. In the microcomputer 20, the CPU 21, the RAM 22, the ROM 23, an AD converter 24, the peripheral circuits 25_1 to 25_{—}n, a communication circuit 27, the DVFS control circuit 5, the clock supply circuit 6, and the power supply circuit 7 are mounted. A sensor 18 is coupled to the microcomputer 20, and the microcomputer 20 can be coupled to a data center 19 on the outside via a data communication path. Each of the CPU 21, the RAM 22, the ROM 23, the AD converter 24, the peripheral circuits 25_1 to 25_{—}n, the communication circuit 27, and the DVFS control circuit 5 is coupled to the bus 30. The DVFS control circuit 5, the clock supply circuit 6, and the power supply circuit 7 are, for example, the circuits described with reference to FIG. 8 in the second embodiment. Although not illustrated, the DVFS control circuit 5 includes the DVFS control register 11, the frequency control register 13, and the voltage control register 14. The DVFS control register 11 is a register for storing the start bit for starting the DVFS control. The clock supply circuit 6 supplies the operation having the frequency designated by the frequency control register 13, and the power supply circuit 7 supplies the power of the operating voltage designated by the voltage control register 14. The frequency control register 13 and the voltage control register 14 are address-mapped in the memory space of the processor, and the CPU 21 can access the frequency control register 13 and the voltage control register 14 by a load/store instruction to the memory. Although not limited, the microcomputer 20 is formed, for example, on a single semiconductor substrate such as silicon by using a known CMOS LSI manufacturing technique.

The microcomputer 20 samples analog data supplied from the sensor 18, converts the data into digital data by the AD converter 24, performs computing processes such as an averaging process, significance determination, and the like by the CPU 21 and, after that, performs a process of transmitting the digital data to the data center 19 on the outside. It performs the processes within a predetermined time.

The execution procedure of the sixth embodiment will be described.

The consumption power profile 2 when the processor of the DVFS control target circuit 8 executes a program for a process as a DVFS control target in the above-described processes is obtained by using a simulation tool or the actual device evaluation environment 1. FIG. 23 is a schematic waveform chart expressing an example of the obtained power profile 2. It is the consumption power profile 2 in the case where the microcomputer 20 executes the operation to transmit the data received from the sensor 18 to the data center 19 on the outside at a constant predetermined clock frequency. The period from time 0 to time T1 is a period of sampling analog data supplied from the sensor 18 and converting it to digital data by the AD converter 24 and, after that, transferring the digital data to the RAM 22. The power value from the time 0 to the time T1 is set as P0. The period from the time T1 to time T2 is a period in which the CPU 21 reads the data stored in the RAM 22, performs the computing processes such as the averaging process, the significance determination, and the like, and stores the resultant data into a transmission register 29 as transmission data to the data center 19. The power value from the time T1 to the time T2 is set as 3P0. The period from the time T2 to time T is a period until the transmission data stored in the transmission register 29 is transmitted from the communication circuit 27 to the data center 19 on the outside. The power value from the time T2 to the time T is set as 2P0.

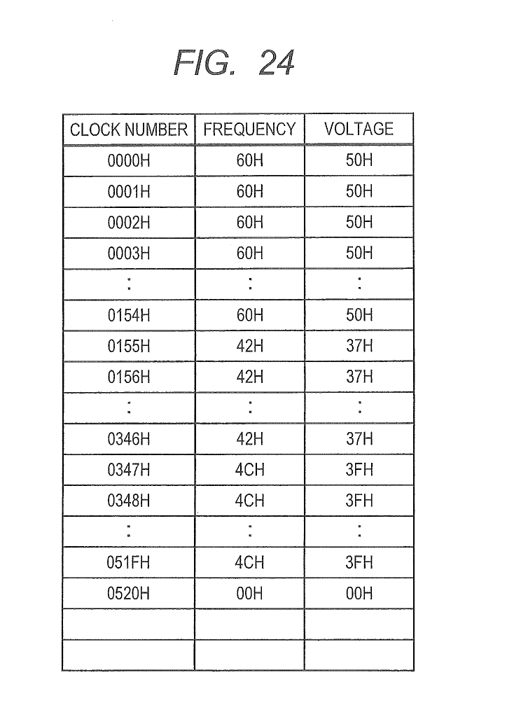

Subsequently, on the basis of the obtained power profile 2, the calculation tool 3 of the Euler equation solution outputs the frequency and voltage control data 4. FIG. 24 is a table expressing an example of the calculated control data 4. Times 0, T1, T2, and T in FIG. 23 correspond to the clock numbers 0000H, 0155H, 0347H, and 0520H, respectively. According to the calculated control data 4, in the period from the clock number 0000H to 0154H, 60H and 50H are stored in the frequency control register 13 and the voltage control register 14, respectively. After that, in the period from the clock number 0155H to 0346H, 42H and 37H are stored as the frequency and voltage, respectively. In the period from the clock number 0347H to 051FH, 4CH and 3FH are stored as the frequency and voltage, respectively. In the clock number 0520H corresponding to the time T at which the process as a DVFS control target completes, standard initial values are set in the frequency control register 13 and the voltage control register 14.

The method of the DVFS control based on the calculated control data 4 can be realized by adding a data write instruction to the frequency control register 13 and the voltage control register 14, for example, a store instruction to a mapped address to a point at which the frequency and voltage are to be changed as described in the second embodiment. It will be described more specifically below.

The clock number in FIG. 24 and an instruction code of a program executing a process as a DVFS control target by the CPU 21 are associated. Just before an instruction code of executing the clock number 0000H, an instruction of setting data 60H and 50H of the frequency and voltage according to the control data 4 into the frequency control register 13 and the voltage control register 14, respectively, is inserted. Further, just before an instruction code of executing the clock number 0155H, an instruction of setting data 42H and 37H of the frequency and voltage according to the control data 4 into the frequency control register 13 and the voltage control register 14, respectively, is inserted. Further, just before an instruction code of executing the clock number 0347H, an instruction of setting data 4CH and 3FH of the frequency and voltage according to the control data 4 into the frequency control register 13 and the voltage control register 14, respectively, is inserted. Finally, just before an instruction code of executing the clock number 0520H, an instruction of setting specified initial data of the frequency and voltage into the frequency control register 13 and the voltage control register 14, respectively, is inserted.

On start of the DVFS control, first, the CPU 21 executes the instruction of writing data to the frequency control register 13 and the voltage control register 14, thereby setting the data 60H in the frequency control register 13 and setting the data 50H in the voltage control register 14. The clock supply circuit 6 supplies a clock having a frequency designated according to the value in the frequency control register 13 to the CPU 21 and the like as the DVFS target circuit 8. The power supply circuit 7 supplies the power of the designated voltage to the entire microcomputer 20 in accordance with the value of the voltage control register 14.

In this state, first, the AD converter 24 samples an analog signal supplied from the sensor 18 and converts it to digital data. The converted digital data is transferred to the RAM 22 via the CPU 21. When the processes since the sampling of the data of the sensor 18 until storage of the digital data into the RAM 22 are completed by a specified number of times, the clock number becomes 0154H.

Next, the instruction of setting the 42H and 37H of the frequency and voltage according to the control data 4 into the frequency control register 13 and the voltage control register 14, respectively, which is added just before the instruction code of executing the clock number 0155H is executed. By the added instruction of writing data to the frequency control register 13 and the voltage control register 14, the data 42H is set in the frequency control register 13 and the data 37H is set in the voltage control register 14. The clock supply circuit 6 supplies a clock having a frequency designated according to the value of the frequency control register 13 into the CPU 21 and the like as the DVFS target circuit 8. The power supply circuit 7 supplies the power of the voltage designated according to the value of the voltage control register 14 to the entire microcomputer 20. In this state, the CPU 21 starts the computing process on the data stored in the RAM 22. For example, the CPU 21 reads a group of the sampled digital data from the RAM 22, performs computing processes such as an averaging process and significance determination, and stores the computation result as transmission data to be transmitted to the data center 19 on the outside into the transmission register 29 of the communication circuit 27. At the time point when the series of processes is finished, the clock number becomes 0346H.

Next, the instruction of setting the 4CH and 3FH of the frequency and voltage according to the control data 4 into the frequency control register 13 and the voltage control register 14, respectively, which is added just before the instruction code of executing the clock number 0347H is executed. By the added instruction of writing data to the frequency control register 13 and the voltage control register 14, the data 4CH is set in the frequency control register 13 and the data 3FH is set in the voltage control register 14. The clock supply circuit 6 supplies a clock having a frequency designated according to the value of the frequency control register 13 into the CPU 21 and the like as the DVFS target circuit 8. The power supply circuit 7 supplies the power of the voltage designated according to the value of the voltage control register 14 to the entire microcomputer 20.

Next, in this state, the CPU 21 sets a communication start bit 28 in the communication circuit 27. In response, the communication circuit 27 starts transmitting the transmission data stored in the transmission register 29 in the communication circuit 27 to the data center 19 on the outside. After that, at the time point when the communication circuit 27 finishes transmitting all of the data in the transmission register 29, the clock number becomes 051FH.

Subsequently, the instruction of setting the specified initial data of the frequency and voltage according to the control data 4 into the frequency control register 13 and the voltage control register 14, respectively, which is added just before the instruction code of executing the clock number 0520H is executed, and the control circuit 12 completes the DVFS operation.

The embodiment of configuring the DVFS control circuit 5 in a manner similar to that of the second embodiment and adding an instruction of writing data to the frequency control register 13 and the voltage control register 14 in association with a change point of the control data 4 to a program has been described above. The DVFS control circuit 5 may be configured as described in the third embodiment. Specifically, like in FIG. 13, the DVFS control circuit 5 further includes the clock number counter 10, the data registers 90 to 9n, and the clock number match detection/data output circuit 17, and the data of the change points is stored in the data registers 90 to 9n. When there is a match with the clock number counted by the clock number counter 10, corresponding data is transferred to the frequency control register 13 and the voltage control register 14. It will be more specifically described below with reference to FIG. 13 in addition to FIGS. 22 to 24.

It is assumed that the data (clock number, frequency, voltage)=(0000H, 60H, 50H), (0155H, 42H, 37H), (0347H, 4CH, 3FH), and (0520H, 00H, 00H) in FIG. 24 is preliminarily stored in the ROM 23 in FIG. 22. Before starting the DVFS control, the CPU 21 reads data from the ROM 23 and sequentially stores it into the data registers 90 to 93. Concretely, the data of (clock number, frequency, voltage)=(0000H, 60H, 50H) is stored into the data register 90. The data of (clock number, frequency, voltage)=(0155H, 42H, 37H) is stored into the data register 91. The data of (clock number, frequency, voltage)=(0347H, 4CH, 3FH) is stored into the data register 92. The data of (clock number, frequency, voltage)=(0520H, 00H, 00H) is stored into the data register 93.

On start of the DVFS control, first, when the CPU 21 executes the instruction of setting the start bit to the DVFS control register 11, the control circuit 12 in the DVFS control circuit 5 starts operating.

The control circuit 12 starts the clock number counting operation of the clock number counter 10. Since the initial value of the clock number counter 10 is 0000H, the clock number match detection/data output circuit 17 detects a match between the clock number 0000H of the data register 90 and the value of the clock number counter 10, and transfers the data 60H and 50H of the frequency and voltage stored in the data register 90 to the control circuit 12. The control circuit 12 sets the received data of frequency and voltage into the frequency control register 13 and the voltage control register 14, respectively. The clock supply circuit 6 supplies a clock having a frequency designated according to the value in the frequency control register 13 to the CPU 21 and the like as the DVFS target circuit 8. The power supply circuit 7 supplies the power of a voltage designated according to the value in the voltage control register 14 to the entire microcomputer 20.

In this state, first, the AD converter 24 samples an analog signal supplied from the sensor 18 and converts it to digital data. The converted digital data is transferred to the RAM 22 via the CPU 21. When the processes since the sampling of the data of the sensor 18 until storage of the digital data into the RAM 22 are completed by a specified number of times, the value of the clock number counter 10 becomes 0155H.

At this time, the clock number match detection/data output circuit 17 detects a match between the clock number 0155H of the data register 91 and the value of the clock number counter 10, and transfers the data 42H and 37H of the frequency and voltage stored in the data register 91 to the control circuit 12. The control circuit 12 sets the received data 42H and 37H of frequency and voltage into the frequency control register 13 and the voltage control register 14, respectively. The clock supply circuit 6 supplies a clock having a frequency designated according to the value in the frequency control register 13 to the CPU 21 and the like as the DVFS target circuit 8. The power supply circuit 7 supplies the power of a voltage designated according to the value in the voltage control register 14 to the entire microcomputer 20.

Next, in this state, the CPU 21 starts a computing process on the data stored in the RAM 22. For example, the CPU 21 reads a group of the sampled digital data from the RAM 22, performs computing processes such as an averaging process and significance determination, and stores the computation result as transmission data to be transmitted to the data center 19 on the outside into the transmission register 29 of the communication circuit 27. At the time point, the value of the clock number counter 10 becomes 0347H.

At this time, the clock number match detection/data output circuit 17 detects a match between the clock number 0347H of the data register 92 and the value of the clock number counter 10, and transfers the data 4CH and 3FH of the frequency and voltage stored in the data register 92 to the control circuit 12. The control circuit 12 sets the received data 4CH and 3FH of frequency and voltage into the frequency control register 13 and the voltage control register 14, respectively. The clock supply circuit 6 supplies a clock having a frequency designated according to the value in the frequency control register 13 to the CPU 21 and the like as the DVFS target circuit 8. The power supply circuit 7 supplies the power of a voltage designated according to the value in the voltage control register 14 to the entire microcomputer 20.

Next, in this state, the CPU 21 sets the communication start bit 28 in the communication circuit 27. In response, the communication circuit 27 starts transmitting the transmission data stored in the transmission register 29 in the communication circuit 27 to the data center 19 on the outside. After that, at the time point when the communication circuit 27 finishes transmitting all of the data in the transmission register 29, the value of the clock number counter 10 becomes 0520H.

At this time, the clock number match detection/data output circuit 17 detects a match between the clock number 0520H of the data register 93 and the value of the clock number counter 10, and transfers the data 00H and 00H of the frequency and voltage stored in the data register 93 to the control circuit 12. The data of the frequency and voltage at this time is 0000H. On receipt of the data 0000H, the control circuit 12 detects that the DVFS control is finished and sets the specified initial values in the frequency control register 13 and the voltage control register 14. At the same time, the control circuit 12 clears the start bit in the DVFS control register 11 and the value of the clock number counter 10, and the DVFS operation is completed.

The case of configuring the DVFS control circuit 5 in a manner similar to that of the third embodiment has been described above. In the case where the calculated control data 4 smoothly changes and a characteristic change point cannot be specified, a configuration similar to that described in the fourth embodiment may be employed. Specifically, the DVFS control circuit 5 further includes the clock number counter 10 and the memory 9, and data of corresponding frequency and voltage is stored in an address in the memory 9 corresponding to the clock number. The memory 9 is accessed using the clock number counted by the clock number counter 10, and the corresponding data is transferred to the frequency control register 13 and the voltage control register 14.

By performing the DVFS control described in the second, third, or fourth embodiment on the series of processes from the sensor data sampling in the sensor/microcomputer system to communication to the data center as described above, the microcomputer operation with minimized consumption energy can be realized.

Although the invention achieved by the inventors herein has been described above concretely on the basis of the embodiments, obviously, the present invention is not limited to the foregoing embodiments but can be variously modified without departing from the gist of the present invention.

For example, one LSI or one system may include a plurality of logic circuits as targets of the DVFS control. A CPU may be subjected to the DVFS control in a mode as described in the second embodiment, an accelerator as a control target of the CPU, which is integrated on the same chip and a peripheral circuit module may be subjected to the DVFS control independently of the control on the CPU in a mode as described in the third or fourth embodiment.

What is claimed is:

1. A method of designing a semiconductor device, by executing a designing assistance program by a computer, for a logic circuit to which an operating voltage and an operating frequency are given and which executes a predetermined process synchronously with a clock signal, the method for calculating an operating voltage and an operating frequency of the logic circuit in a period in which the process is executed, comprising the steps of:
providing, as a power profile, a relation of consumption power to a clock cycle accompanying execution of the process when the process is executed by giving a first operating voltage and a first operating frequency to the logic circuit;
obtaining, as a load capacity function, a function of load capacity of the logic circuit, for the clock cycle accompanying execution of the process on the basis of the power profile; and
calculating, each as a function for the clock cycle, the operating voltage and the operating frequency of the logic circuit in the period in which the process is executed so as to satisfy an Euler equation with respect to power and a clock cycle on the basis of the load capacity function.

2. The method of designing a semiconductor device according to claim 1,
wherein the first operating voltage and the first operating frequency are constant through a period of executing the process, and
wherein the load capacity function is calculated from the power profile, the first operating voltage, and the first operating frequency.

3. The method of designing a semiconductor device according to claim 1,
wherein the logic circuit can execute a program and includes a processor capable of setting an operating voltage and an operating frequency by an instruction included in the program, and
wherein an instruction of setting an operating voltage and an operating frequency on the basis of an operating voltage and an operating frequency each calculated as a function for a clock cycle is added to the program executing the process.

4. The method of designing a semiconductor device according to claim 1,
wherein a control circuit capable of setting an operating voltage and an operating frequency to be supplied to the logic circuit is coupled to the logic circuit,
wherein the control circuit has a clock counter, when control data in which an operating voltage and an operating frequency are specified so as to be associated with a clock cycle value, a count value by the clock counter, and a clock cycle value specified in the control data are compared and, when there is a match, a corresponding operating voltage and a corresponding operating frequency can be set as the operating voltage and operating frequency to be supplied to the logic circuit, and
wherein the control data is generated on the basis of the operating voltage and the operating frequency each calculated as a function for the clock cycle.

5. The method of designing a semiconductor device according to claim 4, wherein the control data includes an operating voltage and an operating frequency to be set for all of clock cycles in the process.

6. A designing assistance program, by being executed by a computer, making the computer execute the method of designing a semiconductor device according to claim 1.

7. The designing assistance program according to claim 6, wherein the power profile is calculated by a simulation on the basis of netlist information in the logic circuit.

8. A designing apparatus comprising a computer executing a designing assistance program according to claim 6.

9. A semiconductor device comprising a processor, a memory capable of storing a program to be supplied to the processor, a clock supply circuit capable of supplying a clock to the processor, a power supply circuit capable of supplying power to the processor, and a control circuit,
wherein the control circuit has a frequency control register capable of setting frequency of the clock supplied from the clock supply circuit to the processor, and a voltage control register capable of setting voltage of the power supplied from the power supply circuit to the processor,
wherein an instruction set of the processor includes an instruction capable of setting a value in each of the frequency control register and the voltage control register,
wherein the program includes a routine of making the processor execute a predetermined process, and the routine includes an instruction of setting an operating voltage and an operating frequency,
wherein the operating voltage and the operating frequency set in the routine are calculated on the basis of an operating voltage function and an operating frequency function each calculated as a function for a clock cycle when the routine is executed,
wherein a relation of consumption power to a clock cycle accompanying execution of the routine when a first operating frequency and a first operating frequency are given and the processor is made execute the routine is provided as a power profile, a relation of load capacity of the processor for the clock cycle is obtained as a load capacity function on the basis of the power profile, and the operating voltage function and the operating frequency function are calculated so as to satisfy an Euler equation with respect to the power and the clock cycle on the basis of the load capacity function.

10. The semiconductor device according to claim 9, wherein the processor includes a plurality of CPUs.

11. The semiconductor device according to claim 9, which is mounted on a single semiconductor substrate.

12. A semiconductor device comprising a logic circuit which operates synchronously with a clock, a clock supply circuit capable of supplying the clock to the logic circuit, a power supply circuit capable of supplying power to the logic circuit, and a control circuit,
wherein the control circuit has a frequency control register capable of setting frequency of the clock supplied from the clock supply circuit to the logic circuit, a voltage control register capable of setting voltage of the power supplied from the power supply circuit to the logic circuit, and a memory capable of holding control data in which an operating voltage and an operating frequency are specified so as to be associated with a clock cycle value, and is configured so as to be able to set a corresponding operating voltage and a corresponding operating frequency into the frequency control register and the voltage control register, respectively when a clock cycle in operation of the logic circuit and a clock cycle value held in the memory match,
wherein the control data is calculated on the basis of an operating voltage function and an operating frequency function each calculated as a function for a clock cycle when the logic circuit executes the process,
wherein a relation of consumption power to a clock cycle accompanying execution of the routine when a first operating frequency and a first operating frequency are given and the logic circuit is made execute the routine is provided as a power profile, a relation of load capacity of the processor for the clock cycle is obtained as a load capacity function on the basis of the power profile, and the operating voltage function and the operating frequency function are calculated so as to satisfy an Euler equation with respect to the power and the clock cycle on the basis of the load capacity function.

13. The semiconductor device according to claim 12,
wherein the memory includes a plurality of data registers, the control circuit further comprises a clock counter for counting the clock and a match detection circuit comparing a count value by the clock counter and a clock cycle value specified in the control data,
wherein setting data specifying a clock cycle value, a corresponding operating voltage, and a corresponding operating frequency specified in the control data is held in the plurality of data registers, and
wherein when the match detection circuit detects that the count value by the clock counter and the clock cycle value held in the data registers match, setting data specifying a corresponding operating voltage and a corresponding operating frequency can be set into the frequency control register and the voltage control register, respectively.

14. The semiconductor device according to claim 12,
wherein the control circuit further comprises a clock counter for counting the clock, and the memory stores setting data specifying a corresponding operating voltage and a corresponding operating frequency, in an address corresponding to a clock cycle value of the control data, and
wherein a clock cycle value which is output from the clock counter is supplied as an address to the memory, setting data specifying a corresponding operating voltage and a corresponding operating frequency is read, and the control circuit can set the setting data specifying the operating voltage and the operating frequency read from the memory into the frequency control register and the voltage control register, respectively.

15. The semiconductor device according to claim 14, wherein the memory is a nonvolatile memory.

16. The semiconductor device according to claim 12, which is mounted on a single semiconductor substrate.
